(19) United States
(12) Patent Application Publication
(10) Pub. No.: US 2018/0295421 A1
(43) Pub. Date: Oct. 11, 2018

(54) DIGITAL DEVICE AND DIGITAL DEVICE CONTROL METHOD

(71) Applicant: LG ELECTRONICS INC., Seoul (KR)

(72) Inventors: Seijun LIM, Seoul (KR); Kyoungryul KIM, Seoul (KR); Youngkyung JUNG, Seoul (KR); Hyeongjin IM, Seoul (KR); Kiho LEE, Seoul (KR)

(73) Assignee: LG ELECTRONICS INC., Seoul (KR)

(21) Appl. No.: 15/570,701

(22) PCT Filed: Apr. 30, 2015
(86) PCT No.: PCT/KR2015/004376

§ 371 Date: Oct. 30, 2017

(51) Int. Cl. H04N 21/472; H04N 21/431; G06F 3/0482; H04N 21/2187; H04N 21/45; H04N 21/442

(52) U.S. Cl. CPC H04N 21/472; H04N 21/4312; H04N 21/44222; H04N 21/2187; H04N 21/4532; G06F 3/0482

(57) ABSTRACT

The present specification discloses a digital device and a digital device control method. Here, a digital device according to an embodiment of the present invention comprises: a reception unit for receiving a content and signaling data for the content; a user input reception unit for receiving a first user input for calling a menu; a decoder for decoding the content and the signaling data; a control unit for controlling the decoded content to be output on a screen, and controlling a menu screen to be overlaid on and output in a predetermined area on the screen on which the content has been output according to the first user input; and an output unit for outputting the content and the menu screen, wherein the control unit controls the menu screen to be output while including an application list or a content list including at least one content relating to the content having been output on the screen, controls a GUI for menu screen configuration switching of the output menu screen to be output when a pointer within the menu screen is located in or hovers on a predetermined area, and controls the menu screen configuration to be switched according to a user's selection through the output GUI.

### TECHNICAL FIELD

The present invention relates to a digital device, and more particularly, to a digital device and control method thereof, suitable for maximizing user's use convenience through a more intuitive and faster content access by configuring a content-oriented menu.

### BACKGROUND ART

The rapid transition from an analog system to a digital system is in progress. Particularly, as the digital system is more robust against eternal noise than the analog system, it has a less data loss and an advantage for error correction and is capable of providing an interactive service.

A digital TV of a related art receives a control signal through a control means (e.g., a remote controller paired by a manufacturer) or key buttons provided to an outer frame/front panel of the digital TV, performs an operation corresponding to the received control signal, and outputs a corresponding result. For example, if a menu is requested through the control means or the key button, the related art digital TV provides a menu screen, which contains formats or contents defaulted by a manufacturer and the like, on a screen. So to speak, the related art digital TV outputs a default content as the requested menu screen. Hence, in order for a user to search for and use a desired function/content or the like through a digital TV, it is inconvenient for the user to go through several depths, separate operations, function buttons and the like. In such an environment, it is difficult for a user to access and use a desired function or content.

### DISCLOSURE OF THE INVENTION

### Technical Task

To solve the above problems, one technical task of the present invention is to provide a digital device, by which a user can access a desired function, data (e.g., content, etc.) more easily and quickly than the related art.

Another technical task of the present invention is to provide a digital device, by which desired data can be accessed and used more easily and quickly through minimum depth or screen change on a paged menu while minimizing disturbance in watching a content currently outputted to a main screen, i.e., a currently watched content.

Further technical task of the present invention is to provide a digital device, which configures and provides a more intuitive menu screen with maximized use convenience than the related art so as to enable everyone to use the digital device easily and conveniently.

Technical tasks obtainable from the present invention are non-limited by the above-mentioned technical task(s). And, other unmentioned technical tasks can be clearly understood from the following description by those having ordinary skill in the technical field to which the present invention pertains.

### Technical Solutions

In one technical aspect of the present invention, provided herein is a digital device, including a receiving unit receiving a content and a signaling data for the content, a user input receiving unit receiving a first user input for a menu calling, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen and wherein if a pointer within the menu screen is located at or hovering on a prescribed region, the controller is configured to control a GUI to be outputted for a menu screen configuration switching of the outputted menu screen and control the menu screen configuration to be switched in response to a user's selection from the outputted GUI.

In another technical aspect of the present invention, provided herein is a digital device, including a receiving unit receiving a content and a signaling data for the content, a user input receiving unit receiving a first user input for a menu calling, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list installed on the digital device and wherein the controller collects history data for the application list configuring the menu screen and controls a preview image to be outputted to one or more applications included in the application list configuring the menu screen based on the collected history data.

In another technical aspect of the present invention, provided herein is a digital device, including a receiving unit receiving a content and a signaling data for the content, a user input receiving unit receiving a first user input for a menu calling and a second user input for a menu selection, a decoder decoding the content and the signaling data, a controller configured to collect a history data for one or more contents used for the device, control the decoded content to be outputted to a screen, and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen in response to the first user input and wherein the controller controls a timeline based content list to be outputted by referring to the collected history data for the one or more contents in response to the second user input.

In another technical aspect of the present invention, provided herein is a digital device, including a receiving unit receiving a content and a signaling data for the content, a user input receiving unit receiving a first user input for a menu calling and a second user input for a menu selection, a decoder decoding the content and the signaling data, a controller configured to collect a history data for one or more contents used for the device, control the decoded content to be outputted to a screen, and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen in response to the first user input, wherein the controller controls a timeline based content list to be outputted by referring to the collected history data for the one or more contents in response to the second user input, and wherein the controller excludes a broadcast hour expiring content or a full-playback ended content from the outputted timeline based content list.

In another technical aspect of the present invention, provided herein is a digital device, including a receiving unit receiving a content and a signaling data for the content, a user input receiving unit receiving a first user input and a second user input related to a menu, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen and an icon for entering a submenu screen, wherein if a pointer within the menu screen is located at or hovering on the icon, the controller is configured to control the submenu screen to be outputted, wherein the submenu screen includes one or more categories, wherein each of the categories includes a content list including one or more contents, and wherein the contents belonging to the content list is controlled to be arranged based on at least one of time data including a season, weather data, emotional data associated with at least one of the time data and the weather data, retrieval ranking, and user's content use pattern data.

In another technical aspect of the present invention, provided herein is a method of providing a menu screen in a digital device, including receiving a content and a signaling data for the content, decoding the content and the signaling data, outputting the decoded content to a screen, receiving a first user input for a menu calling, outputting a menu screen to overlay a prescribed region of the content outputted screen in response to the first user input, the menu screen including an application list or a content list including at least one content related to the content currently outputted to the screen, detecting whether a pointer within the menu screen is located at or hovering on a prescribed region, outputting a GUI for a menu screen configuration switching of the outputted menu screen, and switching to output the menu screen configuration in response to a user's selection from the outputted GUI.

In another technical aspect of the present invention, provided herein is a method of providing a menu screen in a digital device, including receiving a content and a signaling data for the content, decoding the content and the signaling data, outputting the decoded content to a screen, collecting a history data for one or more contents used for the device, receiving a first user input for a menu calling, outputting a menu screen to overlay a prescribed region of the content outputted screen in response to the first user input, the menu screen including an application list or a content list including at least one content related to the content currently outputted to the screen, receiving a second user input for a menu selection, and outputting a timeline based content list by referring to the collected history data for the one or more contents in response to the second user input.

In further technical aspect of the present invention, provided herein is a method of providing a menu screen in a digital device, including receiving a content and a signaling data for the content, decoding the content and the signaling data, outputting the decoded content to a screen, receiving a first user input for a menu calling, outputting a menu screen to overlay a prescribed region of the content outputted screen in response to the first user input, the menu screen including an application list or a content list including at least one content related to the content currently outputted to the screen and an icon for entering a submenu screen, detecting whether a pointer within the menu screen is located at or hovering on the icon, and outputting the submenu screen, wherein the submenu screen includes one or more categories, wherein each of the categories includes a content list including one or more contents, and wherein the contents belonging to the content list is arranged based on at least one of time data including a season, weather data, emotional data associated with at least one of the time data and the weather data, retrieval ranking, and user's content use pattern data.

Technical task(s) obtainable from the present invention are non-limited by the above-mentioned technical task. And, other unmentioned technical tasks can be clearly understood from the following description by those having ordinary skill in the technical field to which the present invention pertains.

### Advantageous Effects

The present invention provides the following features or effects.

According to one of various embodiments of the present invention, a user can access a desired function, data (e.g., content, etc.) more easily and quickly than the related art.

According to another one of various embodiments of the present invention, desired data can be accessed and used more easily and quickly through minimum depth or screen change on a paged menu while minimizing disturbance in watching a content currently outputted to a main screen, i.e., a currently watched content.

According to further one of various embodiments of the present invention, a digital device configures and provides a more intuitive menu screen with maximized use convenience than the related art so as to enable everyone to use the digital device easily and conveniently.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram to schematically describe a service system including a digital device according to one embodiment of the present invention.

FIG. 2 is a block diagram to describe a digital device according to one embodiment of the present invention.

FIG. 3 is a block diagram to describe the configuration of a digital device according to another embodiment of the present invention.

FIG. 4 is a diagram to describe webOS architecture according to one embodiment of the present invention.

FIG. 5 is a diagram to describe architecture of webOS device according to one embodiment of the present invention.

FIG. 6 is a diagram to describe a graphic composition flow in a webOS device according to one embodiment of the present invention.

FIG. 7 is a diagram to describe a media server according to one embodiment of the present invention.

FIG. 8 is a block diagram to describe a configuration of a media server according to one embodiment of the present invention.

FIG. 9 is a diagram to describe the relation between a media server according to one embodiment of the present invention and a TV service.

FIG. 10 is a diagram showing a screen of a digital device currently outputting a content.

FIG. 11 is a diagram showing a digital device outputting a requested menu according to one embodiment of the present invention in detail.

FIGS. 12 to 21 are diagrams to describe a present mode menu configuration and control according to the present invention in detail.

FIGS. 22 to 27 are diagrams to describe a past mode menu configuration and control according to the present invention in detail.

FIGS. 28 to 35 are diagrams to describe a future mode menu configuration and control according to the present invention in detail.

FIG. 36 is a diagram to describe one example of a digital service system according to one embodiment of the present invention in detail.

FIG. 37 is a diagram to describe an embodiment that a menu requested in a digital device 3710 is outputted from a mobile device according to one embodiment of the present invention in detail.

FIG. 38 is a diagram to describe an embodiment for a menu launcher configuration of a mobile device type according to the present invention.

FIG. 39 is a flowchart to describe a menu data processing method in a digital device according to the present invention.

### BEST MODE FOR INVENTION

Description will now be given in detail according to various embodiment(s) for a digital device and method of controlling the same disclosed herein, with reference to the accompanying drawings.

Suffixes such as “module”, “unit” and the like in this disclosure may be used to refer to elements or components. Use of such a suffix herein is merely intended to facilitate description of the specification, and both suffixes may be interchangeably usable. The description with ordinal numbers such as ‘first˜’, ‘second˜’ and the like is provided to facilitate the description of the corresponding terminologies only, which is non-limited by such terminologies or ordinal numbers.

Although terminologies used in the present specification are selected from general terminologies used currently and widely in consideration of functions in the present invention, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the invention. Therefore, terminologies used in the present specification need to be construed based on the substantial meanings of the corresponding terminologies and the overall matters disclosed in the present specification rather than construed as simple names of the terminologies.

Meanwhile, the descriptions disclosed in the present specification and/or drawings correspond to one preferred embodiment of the present invention and are non-limited by the preferred embodiment. And, the scope/extent of the right should be determined through the appended claims.

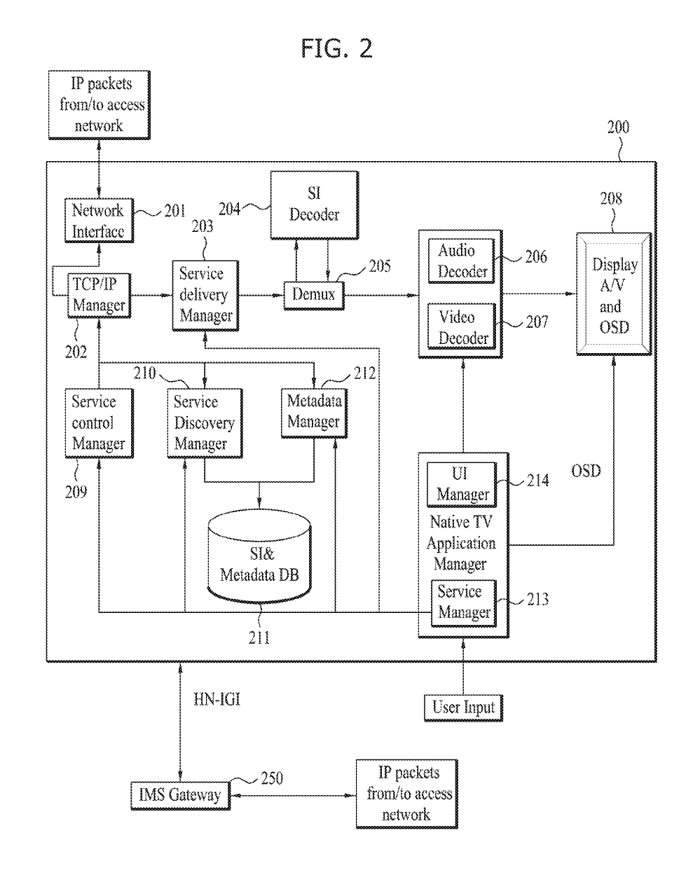

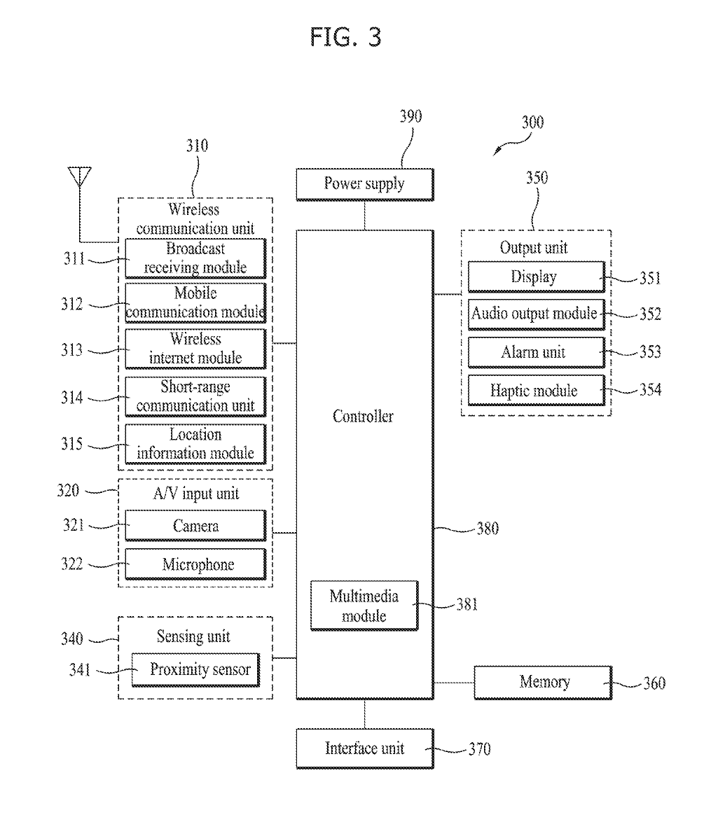

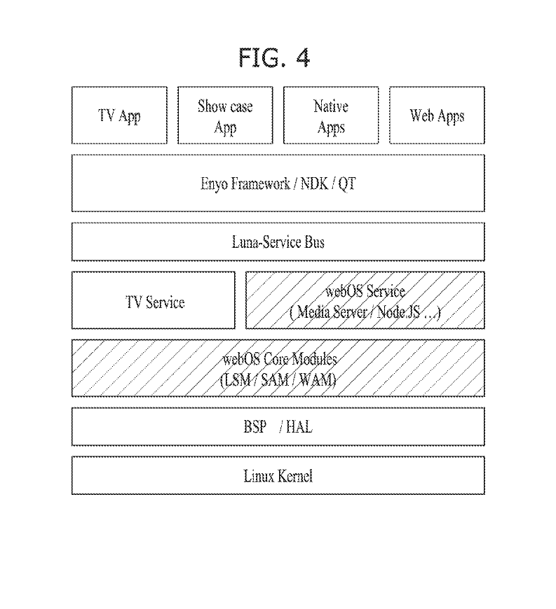

‘Digital device’ described in the present specification includes any device capable of performing at least one of transmission, reception, processing and output of data, content, service, application and the like for example. The digital device can be paired or connected (hereinafter ‘paired’) with another digital device, an external server and the like through wire/wireless network and transmit/receive prescribed data through the pairing. In doing so, if necessary, the data may be appropriately converted before the transmission/reception. The digital devices may include standing devices (e.g., Network TV, HBBTV (Hybrid Broadcast Broadband TV), Smart TV, IPTV (Internet Protocol TV), PC (Personal Computer), etc.) and mobile devices (e.g., PDA (Personal Digital Assistant), Smart Phone, Tablet PC, Notebook, etc.). In the present specification, to help the understanding of the present invention and the clarity of the applicant's description, a digital TV is shown as an embodiment of a digital device in FIG. 2 or FIG. 3 and a mobile device is shown as an embodiment of a digital device in FIG. 4. A digital device described in the present specification may include a panel-only configured digital signage, monitor or display device or a part of a single service system by including a set-top box (STB) or being merged with a server or the like.

Meanwhile, ‘wire/wireless network’ described in the present specification is a common name of a communication network supportive of various communication specifications and/or protocols for the paring or/and data transceiving between digital devices or between a digital device and an external server. Such wire/wireless networks include all communication networks supported currently or all communication networks that will be supported in the future, by the specifications and are capable of supporting one or more communication protocols for the same. Such wire/wireless networks can be established by a network for a wire connection and a communication specification or protocol for the same (e.g., USB (Universal Serial Bus), CVBS (Composite Video Banking Sync), Component, S-video (analog), DVI (Digital Visual Interface), HDMI (High Definition Multimedia Interface), RGB, D-SUB, etc.) and a network for a wireless connection and a communication specification or protocol (e.g., Bluetooth, RFID (Radio Frequency Identification), IrDA (infrared Data Association), UWB (Ultra Wideband), ZigBee, DLNA (Digital Living Network Alliance), WLAN (Wireless LAN)(Wi-Fi), Wibro (Wireless broadband), Wimax (World Interoperability for Microwave Access), HSDPA (High Speed Downlink Packet Access), LTE/LTE-A (Long Term Evolution/LTE-Advanced), Wi-Fi direct).

If a device is named a digital device in this disclosure, the meaning may indicate a standing device or a mobile device according to a context, or can be used to indicate both unless mentioned specially.

Meanwhile, a digital device is an intelligent device supportive of a broadcast receiving function, a computer function or support, at least one external input and the like, and is able to support e-mail, web browsing, banking, game, application and the like through the aforementioned wire/wireless network. Moreover, the digital device may include an interface (e.g., manual input device, touchscreen, space remote controller, etc.) to support at least one input or control means.

Besides, a digital device may use a standardized OS (operating system). Particularly, a digital device described in the present specification uses webOS for one embodiment. Hence, a digital device can process adding, deleting, amending, updating and the like of various services or applications on Universal OS kernel or Linux kernel, through which a further user-friendly environment can be configured and provided.

Meanwhile, the aforementioned digital device can receive and process an external input. Herein, the external input includes an external input device, i.e., any input means or digital device capable of transmitting/receiving and processing data by being connected to the aforementioned digital device through wire/wireless network. For instance, as the external inputs, a game device (e.g., HDMI (High-Definition Multimedia Interface), Playstation, X-Box, etc.), a printing device (e.g., smart phone, tablet PC, pocket photo, etc.), and a digital device (e.g., smart TV, Blu-ray device, etc.) are included.

Besides, ‘server’ described in the present specification means a digital device or system that supplies data to the aforementioned digital device (i.e., client) or receives data from it, and may be called a processor. For example, the server may include a portal server providing web page, web content or web service, an advertising server providing advertising data, a content server providing contents, an SNS server providing SNS (Social Network Service), a service server provided by a manufacturer, an MVPD (Multichannel Video Programming Distributor) providing VoD (Video on Demand) or streaming service, a service server providing a pay service and the like.

Moreover, in case that the following description is made using an application only for clarity in the present specification, it may mean a service as well as an application on the basis of a corresponding content and the like and also include a web application on a webOS platform according to the present invention.

A digital device according to one embodiment of the present invention may include a receiving unit receiving a content and a signaling data for the content, a user input receiving unit receiving a first user input for a menu calling, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen and wherein if a pointer within the menu screen is located at or hovering on a prescribed region, the controller is configured to control a GUI to be outputted for a menu screen configuration switching of the outputted menu screen and control the menu screen configuration to be switched in response to a user's selection from the outputted GUI.

The controller may collect history data for the application list configuring the menu screen, control a preview image to be outputted to one or more applications included in the application list configuring the menu screen based on the collected history data, identify one or more contents included in the content list of the menu screen, and control data for the identified one or more contents to be read from a memory or/and collected from an external server.

The data for the identified one or more contents may include history data for the corresponding content. And, in configuring the content list of the menu screen, the controller may control a preview image for the corresponding content to be outputted based on the history data.

A digital device according to another embodiment of the present invention may include a receiving unit receiving a content and a signaling data for the content, a user input receiving unit receiving a first user input for a menu calling, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list installed on the digital device and wherein the controller collects history data for the application list configuring the menu screen and controls a preview image to be outputted to one or more applications included in the application list configuring the menu screen based on the collected history data.

A digital device according to another embodiment of the present invention may include a receiving unit receiving a content and a signaling data for the content, a user input receiving unit receiving a first user input for a menu calling and a second user input for a menu selection, a decoder decoding the content and the signaling data, a controller configured to collect a history data for one or more contents used for the device, control the decoded content to be outputted to a screen, and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen in response to the first user input and wherein the controller controls a timeline based content list to be outputted by referring to the collected history data for the one or more contents in response to the second user input.

When a corresponding content is a live broadcast program, if the live broadcast program stops being broadcasted, the controller may control the live broadcast program to be excluded from the outputted timeline based content list. When a corresponding content is a streamed or downloaded content, if the corresponding content is completely played, the controller may control the corresponding content to be excluded from the outputted timeline based content list. When a corresponding content is restricted by a viewable time or rating, if the viewable time for the content expires or the viewable rating is changed, the controller may control the corresponding content to be excluded from the outputted timeline based content list.

If a prescribed content belonging to the timeline based content list is selected, the controller may control one or more contents related to the selected content among contents belonging to the content list to be outputted in a manner of being arranged to be adjacent to the selected content. If the content selection is released, the controller may control the content list to be outputted in a manner of being arranged as the timeline based content list before the selection.

A digital device according to another embodiment of the present invention may include a receiving unit receiving a content and a signaling data for the content, a user input receiving unit receiving a first user input for a menu calling and a second user input for a menu selection, a decoder decoding the content and the signaling data, a controller configured to collect a history data for one or more contents used for the device, control the decoded content to be outputted to a screen, and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen in response to the first user input, wherein the controller controls a timeline based content list to be outputted by referring to the collected history data for the one or more contents in response to the second user input, and wherein the controller excludes a broadcast hour expiring content or a full-playback ended content from the outputted timeline based content list.

A digital device according to further of the present invention may include a receiving unit receiving a content and a signaling data for the content, a user input receiving unit receiving a first user input and a second user input related to a menu, a decoder decoding the content and the signaling data, a controller configured to control the decoded content to be outputted to a screen and control a menu screen to be outputted to overlay a prescribed region of the content outputted screen in response to the first user input, and an output unit outputting the content and the menu screen, wherein the controller controls the menu screen to be outputted by including an application list or a content list including at least one content related to the content currently outputted to the screen and an icon for entering a submenu screen, wherein if a pointer within the menu screen is located at or hovering on the icon, the controller is configured to control the submenu screen to be outputted, wherein the submenu screen includes one or more categories, wherein each of the categories includes a content list including one or more contents, and wherein the contents belonging to the content list is controlled to be arranged based on at least one of time data including a season, weather data, emotional data associated with at least one of the time data and the weather data, retrieval ranking, and user's content use pattern data.

The controller may control the icon for entering the submenu screen to be changed based on the time data including the season. The controller may control the arranged contents to be outputted by differing from each other in size based on at least one of the time data including the season, the weather data, the emotional data associated with the at least one of the time data and the weather data, the retrieval ranking, and the user's content use pattern data and an attribute of a corresponding content. If a prescribed content is selected within a corresponding category, the controller may control one or more contents associated with the selected content to be provided by being accessibly rearranged to be adjacent to the selected content. If the content selection is released, the controller may control rearrangement to be performed in arrangement order before the selection. The controller may control a prescribed category among the categories to include a list including at least one of an application and a content based on collected history data and wherein the controller controls the application included in the list to include a preview image based on the history data.

In the following description, the present invention is explained in detail with reference to attached drawings.

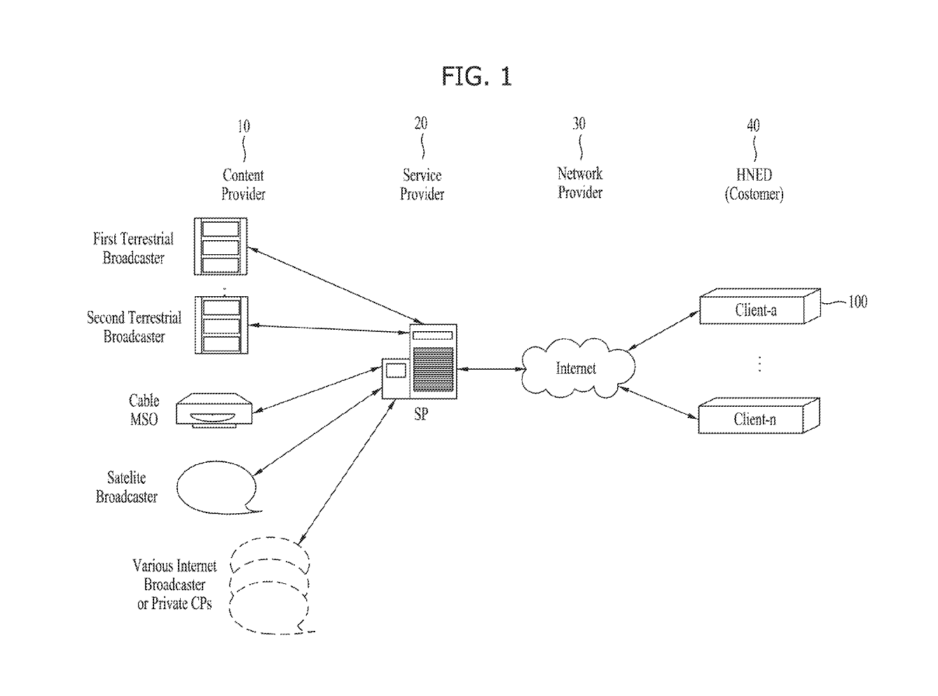

FIG. 1 is a diagram to schematically describe a service system including a digital device according to one embodiment of the present invention.

Referring to FIG. 1, a service system may include a content provider (CP) 10, a service provider (SP) 20, a network provider (NP) 30, and a home network end user (HNED) (Customer) 40. The HNED 40 includes a client 100, that is, a digital device according to the present invention.

The CP 10 produces and provides various contents. Referring to FIG. 1, the CP 10 can include a terrestrial broadcaster, a cable system operator (SO), a multiple system operator (MSO), a satellite broadcaster, various Internet broadcasters, private content providers (CPs), etc. Meanwhile, the CP 10 can produce and provide various services, applications and the like as well as well as broadcast contents.

The SP 20 service-packetizes a content produced by the CP 10 and then provides it to the HNED 40. For instance, the SP 20 packetizes at least one of contents, which are produced by a first terrestrial broadcaster, a second terrestrial broadcaster, a cable MSO, a satellite broadcaster, various internet broadcasters, applications and the like, for a service and then provides it to the HNED 40.

The SP 20 can provide services to the client 100 in a uni-cast or multi-cast manner Meanwhile, the SP 20 can collectively send data to a multitude of pre-registered clients 100. To this end, it is able to use IGMP (internet group management protocol) and the like.

The CP 10 and the SP 20 can be configured in the form of one entity. For example, the CP 10 can function as the SP 20 by producing a content, service-packetizing the produced content, and then providing it to the HNED 40, and vice versa.

The NP 30 provides a network environment for data exchange between the CP 10 and/or the SP 20 and the client 100.

The client 100 is a consumer belonging to the HNED 40. The client 100 may receive data by establishing a home network through the NP 30 for example and transmit/receive data for various services (e.g., VoD, streaming, etc.), applications and the like.

The CP 10 or/and the SP 20 in the service system may use a conditional access or content protection means for the protection of a transmitted content. Hence, the client 100 can use a processing means such as a cable card (CableCARD) (or POD (point of deployment) or a downloadable CAS (DCAS), which corresponds to the conditional access or the content protection.

In addition, the client 100 may use an interactive service through a network as well. In this case, the client 100 can directly serve as a content provider. And, the SP 20 may receive and transmit it to another client or the like.

In FIG. 1, the CP 10 or/and the SP 20 may be a service providing server that will be described later in the present specification. In this case, the server may mean that the NP 30 is owned or included if necessary. In the following description, despite not being specially mentioned, a service or a service data includes an internal service or application as well as a service or application received externally, and such a service or application may mean a service or application data for the webOS based client 100.

FIG. 2 is a block diagram to describe a digital device according to one embodiment of the present invention.

In the following, a digital device mentioned in the present specification may correspond to the client 100 shown in FIG. 1.

The digital device 200 may include a network interface 201, a TCP/IP manager 202, a service delivery manager 203, an SI decoder 204, a demux or demultiplexer 205, an audio decoder 206, a video decoder 207, a display A/V and OSD (On Screen Display) module 208, a service control manager 209, a service discovery manager 210, a SI & metadata database (DB) 211, a metadata manager 212, a service manager 213, a UI manager 214, etc.

The network interface 201 may transmit/receive IP (internet protocol) packet(s) or IP datagram(s) (hereinafter named IP pack(s)) through an accessed network. For instance, the network interface 201 may receive services, applications, contents, side informations and the like from the service provider 20 shown in FIG. 1 through a network. The side information may include SI (system information). Meanwhile, the network interface 201 may coexist with or be substituted with a tuner, a demodulator and the like. The network interface 201 may have Ethernet terminal and the like for an access to a wired network for example. For the access to the wireless network, the network interface 201 may use communication specifications such as WLAN (Wireless LAN) (Wi-Fi), Wibro (Wireless broadband), Wimax (World Interoperability for Microwave Access), HSDPA (High Speed Downlink Packet Access), etc. Meanwhile, the network interface 201 may access a prescribed webpage through the accessed network or another network linked to the accessed network. Namely, the network interface 201 accesses a prescribed webpage through a network and is then able to transceive data with a corresponding server. Besides, the network interface 201 can receive contents or data provided by a content provider or a network operator. Namely, the network interface 201 may receive contents (e.g., movie, advertisement, game, VOD, broadcast signal, etc.) provided by the content provider or a network provider and information associated with the contents through the network. The network interface 201 may receive update information and file of firmware provided by the network operator. And, the network interface 201 may send data to the internet or content provider or the network operator. Moreover, the network interface 201 may select a desired application from open applications and receive it through a network.

The TCP/IP manager 202 may involve delivery of IP packets transmitted to the digital device 200 and IP packets transmitted from the digital device 200, that is, packet delivery between a source and a destination. The TCP/IP manager 202 may classify received packet(s) according to an appropriate protocol and output the classified packet(s) to at least one of the service delivery manager 205, the service discovery manager 210, the service control manager 209, the metadata manager 212, and the like.

The service delivery manager 203 may be in charge of controlling the received service data. The service delivery manager 203 may control real-time streaming data, for example, using RTP/RTCP. In case of transmitting the real-time streaming data using RTP, the service delivery manager 203 may parse the received data packet according to the RTP and then transmits the parsed data packet to the demultiplexer 205 or save the parsed data packet to the SI & metadata DB 211 under the control of the service manager 213. The service delivery manager 203 may feed back the network reception information to the service providing server side using RTCP.

The demultiplexer 205 may demultiplex a received packet into audio data, video data, SI (system information) data and the like and then transmit the demultiplexed data to the audio/video decoder 206/207 and the SI decoder 204, respectively.

The SI decoder 204 may decode the demultiplexed SI data, i.e., service informations of PSI (Program Specific Information), PSIP (Program and System Information Protocol), DVB-SI (Digital Video Broadcasting-Service Information), DTMB/CMMB (Digital Television Terrestrial Multimedia Broadcasting/Coding Mobile Multimedia Broadcasting), etc. And, the SI decoder 204 may save the decoded service informations to the SI & metadata DB 211. The saved service information can be used by being read by a corresponding component in response to a user's request for example.

The audio decoder 206 and the video decoder 207 may decode the demultiplexed audio data and the demultiplexed video data, respectively. The decoded audio and video data may be provided to the user through the display unit 208.

The application manager includes a service manager 213 and a user interface (UI) manager 214 and is able to perform a function of a controller of the digital device 200. So to speak, the application manager can administrate the overall states of the digital device 200, provide a user interface (UI), and manage other mangers.

The UI manager 214 provides a graphical user interface/user interface (GUI/UI) using OSD (on screen display) and the like. The UI manager 214 receives a key input from a user and then performs a device operation according to the input. For instance, if receiving a key input about a channel selection from a user, the UI manager 214 transmits the key input signal to the service manager 213.

The service manager 213 may control and manage service-related managers such as the service delivery manager 203, the service discovery manager 210, the service control manager 209, and the metadata manager 212.

The service manager 213 creates a channel map and controls a selection of a channel and the like using the created channel map in response to a key input received from the UI manager 214. The service manager 213 may receive service information from the SI decoder 204 and then sets an audio/video PID of a selected channel for the demultiplexer 205. Such a PID can be used for the demultiplexing procedure. Therefore, the demultiplexer 205 performs filtering (PID or section filtering) on audio data, video data and SI data using the PID.

The service discovery manager 210 may provide information required to select a service provider that provides a service. Upon receipt of a signal for selecting a channel from the service manager 213, the service discovery manager 210 searches for a service using the information.

The service control manager 209 may select and control a service. For example, the service control manager 209 may perform service selection and control using IGMP (Internet Group Management Protocol) or real time streaming protocol (RTSP) when the user selects a live broadcast service and using RTSP when the user selects a video on demand (VOD) service. The RTSP protocol can provide a trick mode for real-time streaming And, the service control manager 209 may initialize and manage a session through the IMS gateway 250 using IMS (IP multimedia subsystem) and SIP (session initiation protocol). The protocols are exemplary, and other protocols are usable according to implementations.

The metadata manager 212 may manage metadata associated with services and save the metadata to the SI & metadata DB 211.

The SI & metadata DB 211 may store service information decoded by the SI decoder 204, metadata managed by the metadata manager 212, and information required to select a service provider, which is provided by the service discovery manager 210. In addition, the SI & metadata DB 211 can store system set-up data and the like for the system.

The SI & metadata database 211 may be implemented with non-volatile RAM (NVRAM), flash memory and the like.

Meanwhile, an IMS gateway 250 is a gateway in which functions required for an access to an IMS based IPTV service are collected.

A storage unit (not shown) may store programs for various signal processing and controls, and may also store a processed video, audio or data signal. In addition, the storage unit may execute a function of temporarily storing a video, audio or data signal inputted from an external device interface or the network interface 201. The storage unit may store information on a prescribed broadcast channel through a channel memory function. The storage unit 240 may store an application or an application list inputted from the external device interface or the network interface 201. And, the storage unit may store various platforms which will be described later. For example, the storage unit may include storage media of one or more types, such as a flash memory type, a hard disk type, a multimedia card micro type, a card type memory (e.g. SD or XD memory), RAM, EEPROM, etc. The digital device 200 may play content files (a video file, a still image file, a music file, a text file, an application file, etc.) stored in the storage unit and provide them to a user.

The above-described digital device 200 may include a digital broadcast receiver capable of processing digital broadcast signals of ATSC or DVB of a stationary or mobile type. Regarding the digital device according to the present invention, some of the illustrated components may be omitted or new components (not shown) may be further added as required. On the other hand, the digital device may not include the tuner and the demodulator, differently from the aforementioned digital device, and may play a content by receiving the content through the network interface or the external device interface.

FIG. 3 is a block diagram to describe a digital device according to another embodiment of the present invention.

The former description with reference to FIG. 2 is made by taking a digital TV, which is a standing device, as one embodiment of a digital device. And, in FIG. 3, a mobile device is described as another embodiment of a digital device.

Referring to FIG. 3, the mobile device 300 includes a wireless communication unit 310, an A/V (audio/video) input unit 320, a user input unit 330, a sensing unit 340, an output unit 350, a memory 360, an interface unit 370, a controller 380, a power supply unit 390, etc.

The respective components are described in detail as follows.

The wireless communication unit 310 typically includes one or more modules which permit wireless communication between the mobile device 300 and a wireless communication system or network within which the mobile device 300 is located. For instance, the wireless communication unit 310 can include a broadcast receiving module 311, a mobile communication module 312, a wireless Internet module 313, a short-range communication module 314, a location information module 315, etc.

The broadcast receiving module 311 receives a broadcast signal and/or broadcast associated information from an external broadcast managing server via a broadcast channel The broadcast channel may include a satellite channel and a terrestrial channel. The broadcast managing server may mean a server generating to send a broadcast signal and/or broadcast associated information or a server receiving to send a pre-generated broadcast signal and/or broadcast associated information to a terminal. The broadcast signal may be implemented as a TV broadcast signal, a radio broadcast signal, and/or a data broadcast signal, among other signals. If desired, the broadcast signal may further include a broadcast signal combined with a TV or radio broadcast signal. The broadcast associated information includes information associated with a broadcast channel, a broadcast program, or a broadcast service provider. Furthermore, the broadcast associated information can be provided via a mobile communication network. In this case, the broadcast associated information can be received by the mobile communication module 312. The broadcast associated information can be implemented in various forms, e.g., an electronic program guide (EPG), an electronic service guide (ESG), and the like. The broadcast receiving module 311 may be configured to receive digital broadcast signals using broadcasting systems such as ATSC, DVB-T (Digital Video Broadcasting-Terrestrial), DVB-S (Satellite), MediaFLO (Media Forward Link Only), DVB-H (Handheld), ISDB-T (Integrated Services Digital Broadcast-Terrestrial), and the like. Optionally, the broadcast receiving module 311 can be configured to be suitable for other broadcasting systems as well as the above-noted digital broadcasting systems. The broadcast signal and/or broadcast associated information received by the broadcast receiving module 311 may be saved to the memory 360.

The mobile communication module 312 transmits/receives wireless signals to/from at least one of a base station, an external terminal, and a server via a mobile network. Such wireless signals may carry audio signals, video signals, and data of various types according to transceived text/multimedia messages.

The wireless Internet module 313 includes a module for wireless Internet access and may be internally or externally coupled to the mobile device 300. The wireless Internet technology can include WLAN (Wireless LAN) (Wi-Fi), Wibro (Wireless broadband), Wimax (World Interoperability for Microwave Access), HSDPA (High Speed Downlink Packet Access), and the like.

The short-range communication module 314 is a module for short-range communications. Suitable technologies for implementing this module include Bluetooth, radio frequency identification (RFID), infrared data association (IrDA), ultra-wideband (UWB), ZigBee, RS-232, RS-485 and the like.

The location information module 315 is a module for obtaining location information of the mobile terminal 100. And, this module may be implemented with a global positioning system (GPS) module for example

The audio/video (A/V) input unit 320 is configured to provide audio or video signal input. The A/V input unit 320 may include a camera 321, a microphone 322 and the like. The camera 321 receives and processes image frames of still pictures or video, which are obtained by an image sensor in a video call mode or a photographing mode. Furthermore, the processed image frames can be displayed on the display 351.

The image frames processed by the camera 321 can be stored in the memory 360 or transmitted externally via the wireless communication unit 310. Optionally, at least two cameras 321 can be provided according to the environment of usage.

The microphone 322 receives an external audio signal in call mode, recording mode, voice recognition mode, or the like. This audio signal is processed and converted into electrical audio data. The processed audio data is transformed into a format transmittable to a mobile communication base station via the mobile communication module 312 in call mode. The microphone 322 typically includes assorted noise cancelling algorithms to cancel noise generated in the course of receiving the external audio signal.

The user input unit 330 generates input data for a user to control an operation of the terminal. The user input unit 330 may include a keypad, a dome switch, a touchpad (e.g., static pressure/capacitance), a jog wheel, a jog switch, and/or the like.

The sensing unit 340 generates sensing signals for controlling operations of the mobile device 300 using status measurements of various aspects of the mobile terminal. For instance, the sensing unit 340 may detect an open/closed status of the mobile device 300, a location of the mobile device 300, an orientation of the mobile device 300, a presence or absence of user contact with the mobile device 300, an acceleration/deceleration of the mobile device 300, and the like. For example, if the mobile device 300 is moved or inclined, it is able to sense a location or inclination of the mobile device. Moreover, the sensing unit 340 may sense a presence or absence of power provided by the power supply unit 390, a presence or absence of a coupling or other connection between the interface unit 370 and an external device, and the like. Meanwhile, the sensing unit 340 may include a proximity sensor 341 such as NFC (near field communication) and the like.

The output unit 350 generates output relevant to the senses of vision, hearing and touch, and may include the display 351, an audio output module 352, an alarm unit 353, a haptic module 354, and the like.

The display 351 is typically implemented to visually display (output) information processed by the mobile device 300. For instance, if the mobile terminal is operating in phone call mode, the display will generally provide a user interface (UI) or graphical user interface (GUI) related to a phone call. For another instance, if the mobile device 300 is in video call mode or photographing mode, the display 351 may display photographed or/and received images or UI/GUI.

The display module 351 may be implemented using known display technologies. These technologies include, for example, a liquid crystal display (LCD), a thin film transistor-liquid crystal display (TFT-LCD), an organic light-emitting diode display (OLED), a flexible display and a three-dimensional display. The mobile device 300 may include one or more of such displays.

Some of the displays can be implemented in a transparent or optical transmittive type, which can be called a transparent display. A representative example of the transparent display is the TOLED (transparent OLED). A rear configuration of the display 351 can be implemented as the optical transmittive type as well. In this configuration, a user may be able to see an object located in rear of a terminal body through a region occupied by the display 351 of the terminal body.

Two or more displays 351 can be provided to the mobile device 300 in accordance with an implementation type of the mobile device 300. For instance, a plurality of displays can be disposed on the mobile device 300 in a manner of being spaced apart from a single face or being integrally formed on a single face. Alternatively, a plurality of displays may be disposed on different faces of the mobile device 300, respectively.

If the display 351 and a sensor (hereinafter called ‘touch sensor’) for detecting a touch action configure a mutual layer structure, the display 351 is usable as an input device as well as an output device. In this case, the touch sensor can be configured with a touch film, a touch sheet, a touchpad, or the like.

The touch sensor can be configured to convert a pressure applied to a specific portion of the display 351 or a variation of capacitance generated from a specific portion of the display 351 into an electrical input signal. Moreover, the touch sensor is configurable to detect pressure of a touch as well as a touched position or size.

If a touch input is applied to the touch sensor, signal(s) corresponding to the touch input is transferred to a touch controller. The touch controller processes the signal(s) and then transfers the processed signal(s) to the controller 380. Therefore, the controller 380 is able to know whether a prescribed portion of the display 351 is touched.

A proximity sensor 341 can be disposed on an inner region of the mobile device enclosed by the touchscreen or near the touchscreen. The proximity sensor is a sensor that detects a presence or non-presence of an object approaching a prescribed detecting surface or an object existing around the proximity sensor using an electromagnetic field strength or infrared ray without mechanical contact. Hence, the proximity sensor is more durable than a contact type sensor and also has utility higher than that of the contact type sensor.

The proximity sensor may include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor, etc. If the touch screen includes the electrostatic capacity proximity sensor, it is configured to detect the proximity of a pointer using a variation of an electric field according to the proximity of the pointer. In this configuration, the touchscreen (or touch sensor) can be sorted into a proximity sensor.

For clarity and convenience of explanation, an action for enabling the pointer approaching the touch screen to be recognized as placed on the touch screen may be named ‘proximity touch’ and an action of enabling the pointer to actually come into contact with the touch screen may be named ‘contact touch’. And, a position, at which the proximity touch is made to the touch screen using the pointer, may mean a position of the pointer vertically corresponding to the touch screen when the pointer makes the proximity touch.

The proximity sensor detects a proximity touch and a proximity touch pattern (e.g., a proximity touch distance, a proximity touch duration, a proximity touch position, a proximity touch shift state). Information corresponding to the detected proximity touch action and the detected proximity touch pattern can be output to the touch screen.

The audio output module 352 functions in various modes including a call-receiving mode, a call-placing mode, a recording mode, a voice recognition mode, and a broadcast reception mode to output audio data which is received from the wireless communication unit 310 or stored in the memory 360. During operation, the audio output module 352 may output an audio signal related to a function (e.g., call received, message received) executed in the mobile device 300. The audio output module 352 may include a receiver, a speaker, a buzzer and the like.

The alarm unit 353 outputs a signal for announcing the occurrence of an event of the mobile device 300. Typical events occurring in the mobile device may include a call signal received, a message received, a touch input received, and the like. The alarm unit 353 may output a signal for announcing the event occurrence by way of vibration as well as video or audio signal. The video or audio signal can be outputted via the display 351 or the audio output module 352. Hence, the display 351 or the audio output module 352 can be sorted into a part of the alarm unit 353.

The haptic module 354 generates various tactile effects that can be sensed by a user. Vibration is a representative one of the tactile effects generated by the haptic module 354. The strength and pattern of the vibration generated by the haptic module 354 are controllable. For instance, different vibrations can be output in a manner of being synthesized together or can be output in sequence. The haptic module 354 is able to generate various tactile effects as well as the vibration. For instance, the haptic module 354 may generate an effect attributed to the arrangement of pins vertically moving against a contact skin surface, an effect attributed to the injection/suction power of air though an injection/suction hole, an effect attributed to the skim over a skin surface, an effect attributed to a contact with an electrode, an effect attributed to an electrostatic force, and an effect attributed to the representation of a hot/cold sense using an endothermic or exothermic device. The haptic module 354 can be implemented to enable a user to sense the tactile effect through a muscle sense of a finger or an arm as well as to transfer the tactile effect through direct contact. Optionally, two or more haptic modules 354 can be provided to the mobile device 300 in accordance with a configuration type of the mobile device 300.

The memory 360 may store a program for an operation of the controller 380, or may temporarily store inputted/outputted data (e.g., phonebook, message, still image, video, etc.). And, the memory 360 may store data of vibrations and sounds of various patterns outputted in response to a touch input to the touchscreen.

The memory 360 may be implemented using any type or combination of suitable volatile and non-volatile memory or storage devices, including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory or XD memory), or other similar memory or data storage device. Furthermore, the mobile device 300 is able to operate in association with the web storage for performing a storage function of the memory 360 on the Internet.

The interface unit 370 may play a role as a passage to every external device connected to the mobile device 300 with external devices. The interface unit 370 receives data from the external devices, delivers a supplied power to the respective elements of the mobile device 300, or enables data within the mobile device 300 to be transferred to the external devices. For instance, the interface unit 370 may include a wired/wireless headset port, an external charger port, a wired/wireless data port, a memory card port, a port for coupling to a device having an identity module, audio input/output ports, video input/output ports, an earphone port, and the like.

The identity module is a chip for storing various kinds of information for authenticating a use authority of the mobile device 300 and may include User Identify Module (UIM), Subscriber Identity Module (SIM), Universal Subscriber Identity Module (USIM), and the like. A device having the identity module (hereinafter called ‘identity device’) can be manufactured in form of a smart card. Therefore, the identity device is connectible to the mobile device 300 through a port.

When the mobile device 300 is connected to an external cradle, the interface unit 370 becomes a passage for supplying the mobile device 300 with a power from the cradle or a passage for delivering various command signals input from the cradle by a user to the mobile device 300. Each of the various command signals inputted from the cradle or the power can operate as a signal for recognizing that the mobile device 300 is correctly installed in the cradle.

The controller 380 typically controls the overall operations of the mobile device 300. For example, the controller 380 performs the control and processing associated with voice calls, data communications, video calls, and the like. The controller 380 may include a multimedia module 381 that provides multimedia playback. The multimedia module 381 may be configured as a part of the controller 380, or implemented as a separate component. Moreover, the controller 380 is able to perform a pattern recognition processing for recognizing a writing input and a picture drawing input performed on the touchscreen as a text and an image, respectively.

The power supply unit 390 is supplied with an external or internal power and then supplies a power required for an operation of each component, under the control of the controller 380.

Various embodiments described herein may be implemented in a recording medium readable by a computer or a device similar to the computer using software, hardware, or some combination thereof for example.

For hardware implementation, the embodiments described herein may be implemented within at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, and a selective combination thereof. Such embodiments may also be implemented by the controller 180.

For software implementation, the embodiments described herein may be implemented with separate software modules, such as procedures and functions, each of which performs one or more of the functions and operations described herein. The software codes can be implemented with a software application written in any suitable programming language and may be stored in the memory 360, and executed by the controller 380.

Meanwhile, a mobile terminal may extend to a wearable device wearable on a user body beyond a dimension in which a user uses a mobile terminal held in a user's hand. Such wearable devices may include a smart watch, a smart glass, a head mounted display (HMS) and the like. Examples of a mobile terminal extending to a wearable device are described in the following.

A wearable device may be configured to exchange (or link) data with another mobile terminal 300. The short range communication module 314 may sense (or recognize) a communication-available wearable device around the mobile terminal 300. Moreover, if the sensed wearable device is a device authenticated to communicate with the mobile terminal 300, the controller 280 may send at least one portion of data processed by the mobile terminal 300 to the wearable device through the short range communication module 314. Hence, a user may use the data, which is processed by the mobile terminal 300, through the wearable device. For example, if the mobile terminal 300 receives an incoming call, a phone call is performed through the wearable device. If the mobile terminal 300 receives a message, the received message can be checked through the wearable device.

A digital device described in the present specification can be operated by a webOS platform. Hereinafter, such a processing as a webOS based configuration or algorithm may be performed by the controller of the above-described digital device or the like. In this case, the controller is used in a broad sense including the aforementioned controllers. Hence, in the following description, regarding a configuration for processing webOS based or related services, applications, contents and the like in a digital device, a hardware or component including software, firmware and the like may be described in a manner of being named a controller.

Such a webOS based platform may improve development independency and functional extensibility by integrating services, applications and the like based on Luna-service Bus for example and is able to increase application development productivity based on a web application framework. In addition, system resources and the like are efficiently used through a webOS process and resource management, whereby multitasking can be supported.

Meanwhile, a webOS platform described in the present specification may be available not only for stationary devices such as personal computers (PCs), TVs and settop boxes (STBs) but also for mobile devices such as cellular phones, smartphones, tablet PCs, laptops, wearable devices, and the like.

A software structure for a digital device is a monolithic structure capable of solving conventional problems depending on markets and has difficulty in external application with a multi-threading based signal process and closed product. In pursuit of new platform based development, cost innovation through chipset replacement and UI application and external application development efficiency, layering and componentization are performed to obtain a 3-layered structure and an add-on structure for an add-on, a single source product and an open application. Recently, modular design of a software structure has been conducted in order to provide a web open application programming interface (API) for an echo system and modular architecture of a functional unit or a native open API for a game engine, and thus a multi-process structure based on a service structure has been produced.

FIG. 4 is a diagram to describe a webOS architecture according to one embodiment of the present invention.

The architecture of a webOS platform is described with reference to FIG. 4 as follows.

The platform can be mainly classified into a system library based webOS core platform, an application, a service and the like.

The architecture of the webOS platform includes a layered structure. OS, system library(s), and applications exist in a lowest layer, a next layer and a most upper layer, respectively. First of all, regarding the lowest layer, as a Linux kernel is included as an OS layer, Linux may be included as an OS of the digital device. Above the OS layer, BSP/HAL (Board Support Package/Hardware Abstraction layer, webOS core modules layer, service layer, Luna-Service Bus layer, Enyo framework/NDK(Native Developer's Kit)/QT layer, and an application layer (as a most upper layer) exist in order. Meanwhile, some layers can be omitted from the aforementioned webOS layer structure. A plurality of layers can be integrated into a single layer, and vice versa. The webOS core module layer may include LSM (Luna Surface Manager) for managing a surface window and the like, SAM (System & Application Manage) for managing launch, running state and the like of an application, WAM (Web Application Manager) for managing Web application and the like based on WebKit, etc.

The LSM manages an application window appearing on a screen. The LSM is in charge of a display hardware (HW), provides a buffer capable of rendering substance required for applications, and outputs a composition of rendering results of a plurality of application to a screen.

The SAM manages a performance policy per conditions of system and application.

Meanwhile, since webOS may regard a web application (Web App) as a basic application, the WAM is based on Enyo Framework.

A service use of application is performed through Luna-service Bus. A new service may be registered as the Bus, and an application can find and use a service required for itself.

The service layer may include services of various service levels such as TV service, webOS service and the like. Meanwhile, the webOS service may include a media server, a Node.JS and the like. Particularly, Node.JS service supports javascript for example.

The webOS service is Linux process of implementing a function logic and can communicate through Bus. This can be mainly divided into four parts and is constructed with a TV process, services migrating into webOS from an existing TV or services corresponding to manufacturer-differentiated services, webOS common service, and Node.js service developed with javascript and used through Node.js.

The application layer may include all applications supportable by the digital device, e.g., TV application, showcase application, native application Web application, etc.

Application on webOS may be sorted into Web Application, PDK (Palm Development Kit) application, QML (Qt Meta Language or Qt Modeling Language) application and the like according to implementing methods. The Web Application is based on WebKit engine and is run on WAM Runtime. Such a web application is based on Enyo Framework or may be run in a manner of being developed based on general HTML5, CSS (cascading style sheets), and javascript. The PDK application includes a native application and the like developed with C/C++ based on PDK provided for a 3^{rd} party or an external developer. The PDK means a set of development libraries and tools provided to enable a third party (e.g., a game, etc.) to develop a native application (C/C++). The PDK application can be used to develop an application of which performance is significant. The QML application is a Qt based native application and includes basic applications (e.g., card view, home dashboard, virtual keyboard, etc.) provided with webOS platform. Herein, QML is a mark-up language of a script type instead of C++. Meanwhile, in the above description, the native application means an application that is developed with C/C++, complied, and run in binary form. Such a native application has an advantage of a fast running speed.

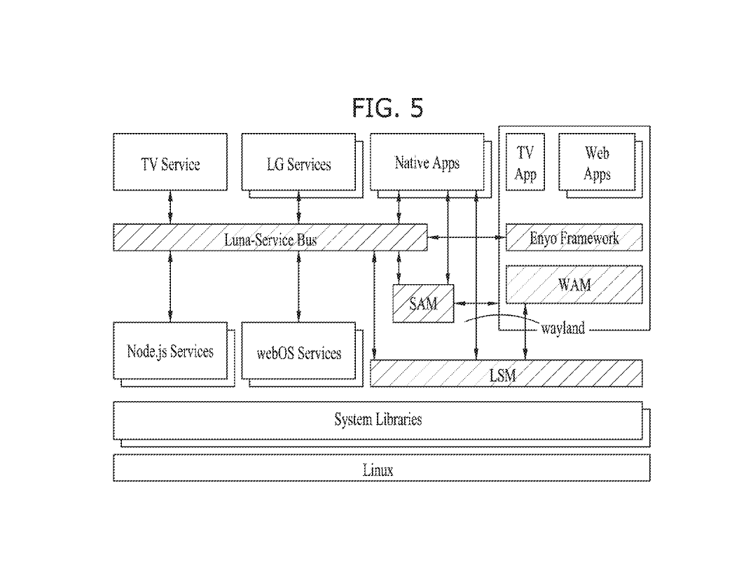

FIG. 5 is a diagram to describe an architecture of webOS device according to one embodiment of the present invention.

FIG. 5 is a block diagram based on a runtime of a webOS device, which can be understood with reference to the layered structure shown in FIG. 4.

The following description is made with reference to FIG. 4 and FIG. 5. Referring to FIG. 5, above a system OS (Linux) and system libraries, services, applications and webOS core modules are included. And, communications among them can be performed through Luna-Service-Bus.

Node.js services (e-mail, contact, calendar, etc.) based on HTML5, CSS, and java script, webOS services such as Logging, backup, file notify, database (DB), activity manager, system policy, AudioD (Audio Daemon), update, media server and the like, TV services such as EPG (Electronic Program Guide), PVR (Personal Video Recorder), data broadcasting and the like, CP services such as voice recognition, Now on, Notification, search, ACR (Auto Content Recognition), CBOX (Contents List Browser), wfdd, DMR, Remote Application, download, SDPIF (Sony Philips Digital Interface Format) and the like, native applications such as PDK applications, browser, QML application and the like, and Enyo Framework based UI related TV applications and Web applications are processed through the webOS core module like the aforementioned SAM, WAM and LSM via Luna-Service-Bus. Meanwhile, in the above description, it is not mandatory for the TV applications and the Web applications to be Enyo-Framework-based or UI-related.

CBOX can manage a list and metadata for contents of such an external device connected to TV as USB, DLNA, Cloud and the like. Meanwhile, the CBOX can output a content listing of various content containers such as USB, DMS, DVR, Cloud and the like in form of an integrated view. And, the CBOX shows a content listing of various types such as picture, music, video and the like and is able to manage the corresponding metadata. Besides, the CBOX can output a content of an attached storage by real time. For instance, if a storage device such as USB is plugged in, the CBOX should be able to output a content list of the corresponding storage device. In doing so, a standardized method for the content list processing may be defined. And, the CBOX may accommodate various connecting protocols.

SAM is provided to enhance improvement and extensibility of module complexity. Namely, for instance, since an existing system manager handles various functions (e.g., system UI, window management, web application run time, constraint condition processing on UX, etc.) by a single process, implementation complexity is very high. Hence, by separating major functions and clarifying an inter-function interface, implementation complexity can be lowered.

LSM supports system UX implementation (e.g., card view, launcher, etc.) to be independently developed and integrated and also supports the system UX implementation to easily cope with a product requirement change and the like. In case of synthesizing a plurality of application screens like App On App, the LSM enables multitasking by utilizing hardware (HW) resource to the maximum, and is able to provide a window management mechanism for multi-window, 21:9 and the like. LSM supports implementation of system UI based on QML and enhances development productivity thereof. QML UX can easily configure a screen layout and a UI component view and facilitates development of a code for processing a user input. Meanwhile, an interface between QML and webOS component is achieved through QML extensive plug-in, and a graphic operation of application may be based on wayland protocol, luna-service call and the like. LSM is an abbreviation of Luna Surface Manager, as described above, and performs a function of an application window compositor. LSM synthesizes an independently developed application, a US component and the like and then outputs the synthesized one to a screen. With respect to this, if components such as Recents application, showcase application, launcher application and the like render contents of their own, respectively, LSM defines an output region, an interoperating method and the like as a compositor. So to speak, the LSM (i.e., compositor) processes graphic synthesis, focus management, input event and the like. In doing so, LSM receives an event, a focus and the like from an input manager. Such an input manager may include a remote controller, an HID (e.g., mouse & keyboard), a joy stick, a game pad, an application remote, a pen touch and the like. Thus, LSM supports a multiple window model and can be simultaneously run on all applications owing to system UI features. With respect to this, LSM can support launcher, recents, setting, notification, system keyboard, volume UI, search, finger gesture, Voice Recognition (STT (Sound to Text), TTS (Text to Sound), NLP (Natural Language Processing), etc.), pattern gesture (camera, MRCU (Mobile Radio Control Unit)), Live menu, ACR (Auto Content Recognition), and the like.

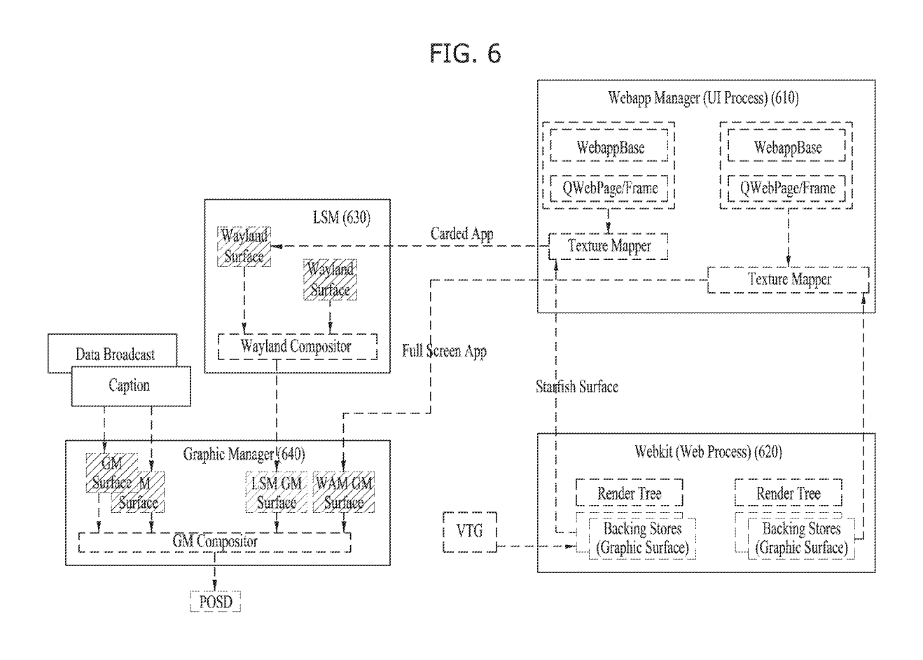

FIG. 6 is a diagram to describe a graphic composition flow in a webOS device according to one embodiment of the present invention.

Referring to FIG. 6, a graphic composition processing can be performed through a web application manager 610 in charge of a UI process, a webkit 620 in charge of a web process, an LSM 630, and a graphic manager (GM) 640.

If a web application based graphic data (or application) is generated as a UI process from the web application manager 610, the generated graphic data is forwarded to a full-screen application or the LSM 630. Meanwhile, the web application manager 610 receives an application generated from the webkit 620 for sharing the GPU (graphic processing unit) memory for the graphic managing between the UI process and the web process and then forwards it to the LSM 630 if the application is not the full-screen application. If the application is the full-screen application, it can bypass the LSM 630. In this case, it may be directly forwarded to the graphic manager 640.

The LSM 630 sends the received UI application to a wayland compositor via a wayland surface. The wayland compositor appropriately processes it and then forwards it to the graphic manager. Thus, the graphic data forwarded by the LSM 630 is forwarded to the graphic manager compositor via the LSM GM surface of the graphic manager 640 for example.

Meanwhile, as described above, the full-screen application is directly forwarded to the graphic manager 640 without passing through the LSM 630. Such an application is processed by the graphic manager compositor via the WAM GM surface. The graphic manager processes all graphic data within the webOS device. The graphic manager receives all the graphic data through the GM surface like data broadcasting application, caption application and the like as well as the data through the LSM GM and the data through the WAM GM surface and then processes them to be outputted to the screen appropriately. Herein, a function of the GM compositor is equal or similar to that of the aforementioned compositor.

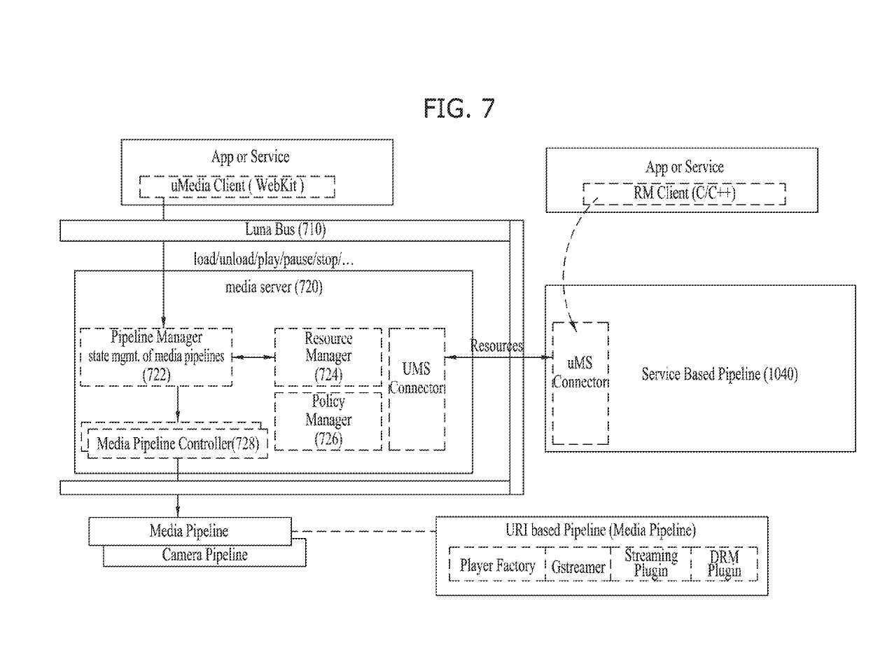

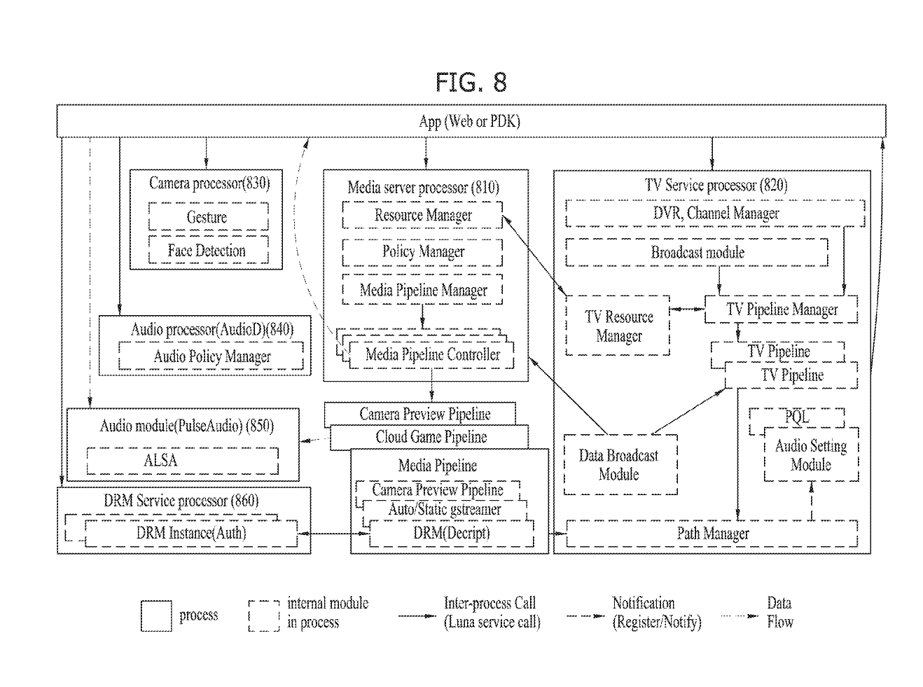

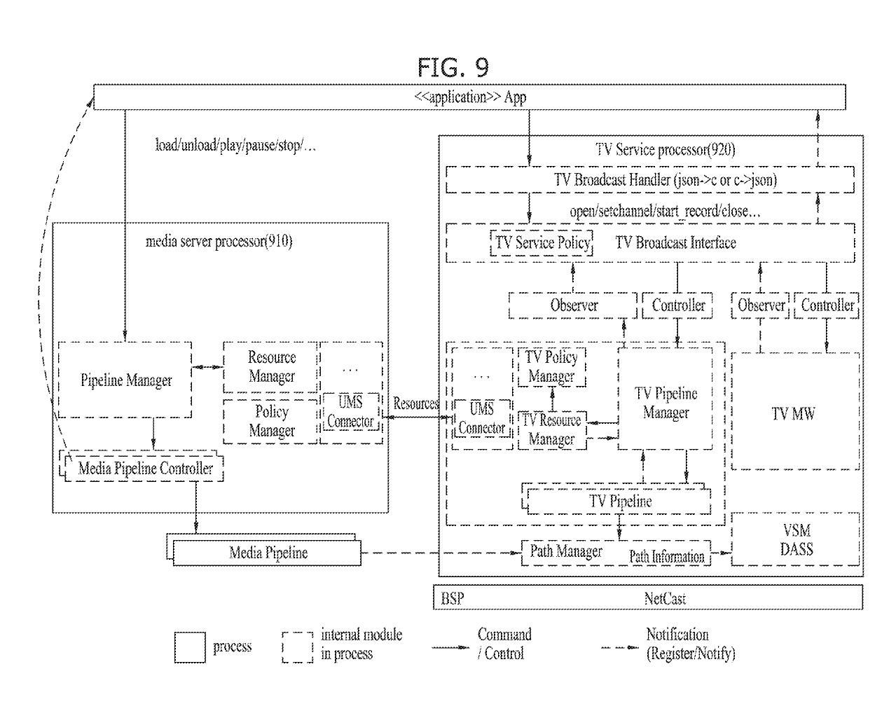

FIG. 7 is a diagram to describe a media server according to one embodiment of the present invention. FIG. 8 is a block diagram to describe a configuration of a media server according to one embodiment of the present invention. FIG. 9 is a diagram to describe the relation between a media server and according to one embodiment of the present invention and a TV service.

Referring to FIG. 7, a media server supports executions of various multimedia in a digital device and manages necessary resources. The media server can efficiently use a hardware resource required for a media play. For instance, the media server needs audio/video hardware resource to execute multimedia, and is able to efficiently utilize the resource by managing a current resource use status. Generally, a stationary (or standing) device having a screen larger than that of a mobile device requires more hardware resources on multimedia execution and needs a faster encoding/decoding and graphic data transfer speed due to a massive data size. Meanwhile, the media server should be able to handle a broadcasting/recording/tuning task, a task of recording at the same time of viewing, a task of displaying both a sender screen and a receiver screen during a video call, and the like as well as a streaming and a file based play. Yet, since hardware resources such as an encoder, a decoder, a tuner, a display engine, and the like are limited by chipset units, it is difficult for the media server to execute several tasks at the same time. Hence, the media server handles the tasks in a manner of restricting a use scenario or receiving an input of user selection.

The media server can add robustness to system stability. For instance, by removing an erroneous play pipeline per pipeline in the course of a media play and then re-maneuvering the media play, another media play is not affected even if such an error occurs. Such a pipeline is a chain of connecting the respective unit functions (e.g., decoding, analysis, output, etc.) in case of a media play request, and necessary unit functions may be changed according to a media type and the like.

The media server may have extensibility. For instance, the media server can add a pipeline of a new type without affecting an existing implementation scheme. For instance, the media server can accommodate a camera pipeline, a video conference (Skype) pipeline, a third-party pipeline and the like.

The media server can handle a general media play and a TV task execution as separate services, respectively. The reason for this is that an interface of a TV service is different from a media play case. In the above description, the media server supports operations of ‘setchanne’, ‘channelup’, ‘channeldown’, ‘channeltuning’, ‘recordstart’ and the like in association with the TV service but supports operations of ‘play’, ‘pause’, ‘stop’ and the like in association with the general media play, thereby supporting different operations for the two services, respectively. Thus, the media server is able to handle the services separately.

The media server may control or manage resource management functions integratedly. Hardware resource allocation, recovery and the like in a device are integratedly performed in the media server. Particularly, a TV service process delivers a currently running task, a current resource allocation status and the like to the media server. Each time each media is executed, the media server secures a resource, activates a pipeline, and performs a grant of execution by a priority (e.g., policy), a resource recovery of other pipelines and the like in response to a media execution request based on a current resource status occupied by each pipeline. Herein, a predefined execution priority and a necessary resource information for a specific request are managed by a policy manager, and a resource manager can handle resource allocation, recovery and the like by communicating with the policy manager.

The media server can retain an ID (identifier) for every operation related to a play. For instance, based on an identifier, the media server can give a command by indicating a specific pipeline. For two or more media plays, the media server may give a command to pipelines by distinguishing the two from each other. The media server may be in charge of a play of HTMS 5 standard media.

Besides, the media server may follow a TV reconfiguration range for a separate service processing of a TV pipeline. The media server can be designed irrespective of the TV reconfiguration range. If the TV is not separately service-processed, when a problem arises from a specific task, the TV may be re-executed entirely.

The media server is so-called uMS, i.e., a micro media server. Herein, a media player is a media client. This may mean a webkit for HTML 5 video tag, camera, TV, Skype, 2^{nd} screen and the like.

A core function of the media server is the management of a micro resource such as a resource manager, a policy manager or the like. With respect to this, the media server controls a playback control role on a web standard media content. Regarding this, the media server may manage a pipeline controller resource.

Such a media server supports extensibility, reliability, efficient resource usage and the like for example.

So to speak, the uMS, i.e., the media server manages and controls the use of resources for an appropriate processing in a WebOS device such as a resource (e.g., cloud game, MVPD (pay service, etc.), camera preview, 2nd screen, Skype, etc.), a TV resource and the like overall, thereby functioning in managing and controlling an efficient usage. Meanwhile, when resources are used, each resource uses a pipeline for example. And, the media server can manage and control generation, deletion, usage and the like of the pipeline for resource management overall. Here, a pipeline may be generated if a media related to a task starts to continue a job such as a parsing of request, decoding stream, video output, or the like. For instance, in association with a TV service or application, watching, recording, channel tuning or the like is individually processed in a manner that a resource usage or the like is controlled through a pipeline generated in response to a corresponding request.

A processing structure of a media server and the like are described in detail with reference to FIG. 8 as follows.

In FIG. 8, an application or service is connected to a media server 820 through a luna-service bus 810. The media server 820 is connected to generated pipelines through the luna-service bus 810 again and manages them.

The application or service is provided with various clients according to its property and is able to exchange data with the media server 820 or the pipelines through them.

The clients may include a uMedia client (webkit) for the connection to the media server 820, an RM (resource manager) client (C/C++) and the like for example.

The application including the uMedia client, as described above, is connected to the media server 820. In particular, the uMedia client corresponds to a video object to be described later. Such a client uses the media server 820 for an operation of a video in response to a request or the like. Here, the video operation relates to a video status. Loading, unloading, play (or, playback, reproduce), pause, stop and the like may include all status data related to video operations. Each operation or status of a video can be processed through individual pipeline generation. Hence, the uMedia client sends status data related to the video operation to the pipeline manager 822 in the media server.

The pipeline manager 822 obtains information on a current resource of a device through data communication with the resource manager 824 and makes a request for allocation of a resource corresponding to the status data of the uMedia client. In doing so, the pipeline manager 822 or the resource manager 824 controls the resource allocation through the data communication with the policy manager 826 if necessary in association with the resource allocation and the like. For instance, if a resource to be allocated by the resource manager in response to the request made by the pipeline manager 822 does not exist or is insufficient, an appropriate resource allocation or the like according to the request can be performed according to priority comparison of the policy manager 826 and the like. Meanwhile, the pipeline manager 822 makes a request for pipeline generation for an operation according to the uMedia client's request for the resource allocated according to the resource allocation of the resource manager 824 to a media pipeline controller 828.

The media pipeline controller 828 generates a necessary pipeline under the control of the pipeline manager 822. Regarding the generated pipelines, as shown in the drawing, pipelines related to play, pause, stop and the like can be generated as well as a media pipeline and a camera pipeline. Meanwhile, the pipelines may include pipelines for HTML5, Web CP, smartshare play, thumbnail extraction, NDK, cinema, MHEG (Multimedia and Hypermedia Information coding Experts Group) and the like.

Besides, pipelines may include a service based pipeline (self-pipeline) and a URI based pipeline (media pipeline) for example.

Referring to FIG. 8, the application or service including the RM client may not be directly connected to the media server 820. The reason for this is that the application or service may directly process a media. So to speak, in case that the application or service directly processes media, the media server can be bypassed. Yet, in doing so, since resource management is necessary for the pipeline generation and usage, a uMS connector functions for it. Meanwhile, if a resource management request for the direct media processing of the application or service is received, the uMS connector communicates with the media server 820 including the resource manager 824. To this end, the media server 820 should be provided with a uMS connector as well.

Hence, by receiving the resource management of the resource manager 824 through the uMS connector, the application or service can cope with the request of the RM client. Such an RM client may process services such as native CP, TV service, 2^{nd} screen, flash player, U-tube MSE (media source extensions), cloud game, Skype and the like. In this case, as described above, the resource manager 824 can manage resource through appropriate data communication with the policy manager 826 if necessary for the resource management.

Meanwhile, the URI based pipeline is processed through the media server 820 instead of the case of directly processing media like the RM client. The URI based pipelines may include player factory, Gstreamer, streaming plug-in, DRM (Digital Rights Management) plug-in pipeline and the like.

A method of interfacing between an application and media services is described as follows.

There is an interfacing method using a service on a web application. This may be a Luna Call method using PSB (palm service bridge) or a method using Cordova. This is to extend a display with a video tag. Besides, there may be a method of using HTMS5 standard for video tag or media element. And, there is a method of interfacing using a service in PDK. Alternatively, there is a method of using a service in an existing CP. This is usable by extending plug-in of an existing platform on the basis of luna for backward compatibility.

Finally, there is an interfacing method in case of non-webOS. In this case, it is able to interface by directly calling a luna bus.

Seamless change is processed by a separate module (e.g., TVWIN), which is a process for showing a TV on a screen preferentially without webOS and then processing seamlessly before or during webOS booting. Since a booting time of webOS is considerably long, it is used to provide basic functions of a TV service preferentially for a quick response to a user's power-on request. And, the module is a part of a TV service process and supports a seamless change capable of providing fast booting and basic TV functions, a factory mode and the like. And, the module may be in charge of a switching from non-webOS mode to webOS mode.

Referring to FIG. 9, a processing structure of a media server is illustrated.

In FIG. 9, a solid line box may indicate a process handling configuration and a dotted line box may indicate an internal processing module in a process. A solid line arrow may include an inter-process call, i.e., a luna service call and a dotted line arrow may indicate a notification of register/notify or a data flow.

A service, a web application or a PDK application (hereinafter ‘application) is connected to various service processing configurations through a luna-service bus. Through it, the application operates or an operation of the application is controlled.

A corresponding data processing path is changed according to a type of an application. For instance, if the application is an image data related to a camera sensor, it is processed by being sent to a camera processor 930. Herein, the camera processor 930 includes a gesture module, a face detection module and the like and processes image data of the application received. Herein, in case of data requiring a usage of a pipeline and the like automatically or according to a user's selection, the camera processor 930 may process the corresponding data by generating the pipeline through a media server processor 910.

Alternatively, if an application includes audio data, the corresponding audio can be processed through an audio processor (AudioD) 940 and an audio module (PulseAudio) 950. For instance, the audio processor 940 processes audio data received from the application and then sends it to an audio module 950. In doing so, the audio processor 940 may determine the processing of the audio data by including an audio policy manager. The processed audio data is processed and handled by the audio module 950. Meanwhile, the application may notify data related to the audio data processing to the audio module 960, which may be notified to the audio module 960 by a related pipeline. The audio module 950 includes ALSA (Advanced Linux Sound Architecture).

Or, in case that an application includes or processes (hereinafter ‘includes’) a DRM hooked content, a corresponding content data is sent to a DRM service processor 960. The DRM service processor 960 generates the DRM hooked content data by generating a DRM instance. Meanwhile, for the processing of the DRM hooked content data, the DRM service processor 960 can be connected to a DRM pipeline in a media pipeline through the luna-service bus.

A processing for a case that an application includes media data or TV service data (e.g., broadcast data) is described as follows.

FIG. 9 is a diagram showing details of the media service processor and the TV service processor in FIG. 8.

The following description is made with reference to FIG. 8 and FIG. 9 both.

First of all, in case that an application includes TV service data, it is processed by the TV service processor 820/920.

Herein, the TV service processor 820 may include at least one of a DVR/channel manager, a broadcast module, a TV pipeline manager, a TV resource manager, a data broadcast module, an audio setting module, a path manager and the like. Alternatively, the TV service processor 920 in FIG. 9 may include a TV broadcast handler, a TV broadcast interface, a service processing unit, a TV middleware (MW), a path manager, and a BSP (NetCast). Herein, the service processing unit may mean a module including a TV pipeline manager, a TV resource manager, a TV policy manager, a USM connector and the like.

In the present specification, The TV service processor may be implemented into the configuration shown in FIG. 8 or FIG. 9 or a combination of both configurations. some of the illustrated components may be omitted or new components (not shown) may be further added as required.

Based on attribute or type of the TV service data received from the application, the TV service processor 820/920 sends DVR or channel associated data to the DVR/channel manager and also sends it to the TV pipeline manager to generate and process a TV pipeline. Meanwhile, if the attribute or type of the TV service data is a broadcast content data, the TV service processor 820 generates and processes a TV pipeline through the TV pipeline manager to process the corresponding data through the broadcast module.

Or, a json (Javascript standard object notation) file or a file composed with c is processed by the TV broadcast handler, sent to the pipeline manager through the TV broadcast interface, and then processed by generating a TV pipeline. In this case, the TV broadcast interface sends the data or file through the TV broadcast handler to the TV pipeline manager on the basis of the TV service policy so that the data or file can be referred to for the pipeline generation.

In the following, a processing process within the TV service processor 920, and more particularly, below the TV broadcast interface is described in detail.

The TV broadcast interface may perform f controller function of the TV service processor 920. The TV broadcast interface makes a request for a pipeline generation to the TV pipeline manager. Then, the TV pipeline manager generates a TV pipeline and makes a request for resources to the TV resource manager. If the TV resource manager makes a resource request to the media server through a UMS connector and then obtains resources, the TV resource manager returns them to the TV pipeline manager.

The TV pipeline manager arranges the returned resources within the generated TV pipeline and registers pipeline information at a path manager. Thereafter, the TV pipeline manager returns the result to the TV pipeline manager. And, the TV pipeline manager returns the pipeline to the TV broadcast interface.

Thereafter, the TV broadcast interface request a channel change and the like by communicating with a TV middleware (MW), and the TV middleware returns the result.

Through the aforementioned process, the TV service can be processed.

The TV pipeline manager may be controlled by the TV resource manager when generating one or more pipelines in response to a TV pipeline generation request from the Processing module or manager in the TV service. Meanwhile, in order to request a status and allocation of a resource allocated for the TV service in response to a TV pipeline generation request made by the TV pipeline manager, the TV resource manager may be controlled by the TV policy manager and performs data communication with the media server processor 810/910 through the uMS connector. The resource manager in the media server processor delivers a status and a presence/non-presence of allocation of a resource for a current TV service in response to a request made by the TV resource manager. For instance, as a result of confirmation of the resource manager within the media server processor 810/910, if all resources for the TV service are already allocated, it is able to notify the TV resource manager that all current resources are completely allocated. In doing so, the resource manager in the media server processor may request or assign TV pipeline generation for the requested TV service by removing a prescribed TV pipeline according to a priority or prescribed reference from TV pipelines previously assigned for the TV service, together with the notification. Alternatively, according to a status report of the resource manager in the media server processor 810/910, the TV resource manager may control TV pipelines to be appropriately removed, added, or established.

Meanwhile, BSP supports backward compatibility with an existing digital device for example.

The above-generated TV pipelines may operate appropriately in the corresponding processing process under the control of the path manager. The path manager may determine or control a processing path or process of pipelines by considering an operation of a pipeline generated by the media server processor 810/910 as well as the TV pipeline in the processing process.

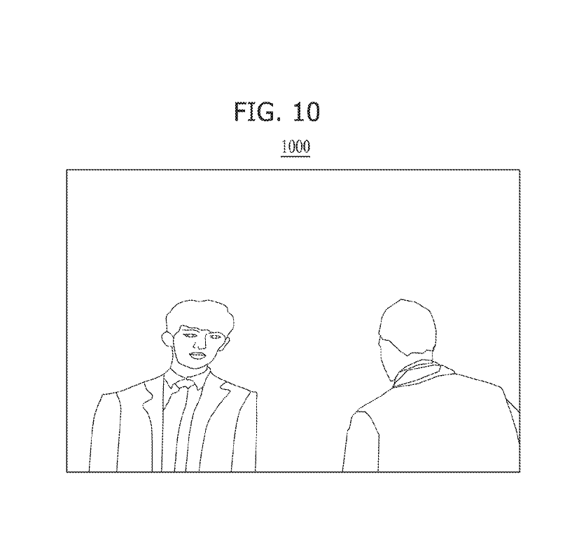

If the application includes media data instead of TV service data, the data is processed by the media server processor 810/910. Herein, the media server processor 810/910 includes a resource manager, a policy manager, a media pipeline manager, a media pipeline controller and the like. Meanwhile, various pipelines generated under the control of the media pipeline manager and the media pipeline controller may include a camera preview pipeline, a cloud game pipeline, a media pipeline and the like. Streaming protocol, auto/static gstreamer, DRM and the like may be included in the media pipeline, of which processing flow may be determined under the control of the path manager. The former description with reference to FIG. 10 is recited for a detailed processing process in the media server processor 810/910, which is not described redundantly herein.

In the present specification, the resource manager in the media server processor 810/910 can perform a resource managing with a counter base for example.

The media server design on the aforementioned webOS platform is described in detail as follows.

A media server is a media framework supporting to enable 3^{rd}-party multimedia pipeline(s) to interface with a webOS platform. The media server can control, manage, isolate and deconflict resources to enable the 3^{rd}-party multimedia pipeline(s) to be compliant. Such a media server may be regarded as a platform module configured to provide a generalized API to enable an application to perform a media play and manage a hardware resource and policy consistently. Meanwhile, a design of a media server is devised to reduce complexity through media processing generalization and associated module separation.

The core of such a media server is to provide integration of service interface and webOS UI. To this end, a media server controls a resource manager, a policy manager and a pipeline manager and provides an API access according to a resource manager query.

A uMS connector is a main API or SDK that enables client media pipeline processes to interface with a media server. A Ums connector is an event or message about an interface. The client media pipelines implement client media pipeline state events for enabling load, play, pause, seek, stop, unload, release_resource, acquire_resource and the like.

A uMedia API provides C, C++ API to the media server.

The media resource manager provides a method of describing a use of media hardware resources and a use of a pipeline client resource using a single simple configuration file. The media resource manager provides all performance and information required for implementing a default or 3^{rd}-party media policy management.

The media policy manager functions when a resource manager declines a media pipeline due to resource conflict. The policy manager can provide consistent API and SDK to enable 3^{rd}-party policy manager implementation. The policy manager supports media pipelines matching LRU (least recently used) and may be used for one or more conflicted resources.

The pipeline manager tracks and maintains client media pipelines. The pipeline controller provides the pipeline manager with a consistent API so as to enable the pipeline manager to control and manage the client media pipelines.

The media server communicates with the resource manager through a library call, and the resource manager can communicate with TV services and a media pipeline through Luna-service Bus.

The media resource manager configures an overall configurable configuration file to describe media hardware and media client pipelines, detects a resource conflict, and collects all information necessary to implement media policy management.

A media policy manager reads policy_select and policy_action fields of a resource configuration file. A resource contention attempts to select an active pipeline described by the policy_select field and issues a problem for outgoing/selected pipelines based on the policy_action field. The selection function may include a parameter supported by a pipeline configuration setting entry. Policy actions include ‘unload’ and ‘release’. All pipelines support an unload command for releasing all allocated resources. A pipeline can additionally support a release command to release a specific resource. In the above description, the release command is provided for fast switch pipelines contending with common resources, and the unload command of all resources may not be required for deconflicting an incoming pipeline.

A pipeline manager manages a pipeline controller. The pipeline manager maintains a cunning queue of the pipeline controller and provides a unique indexing for an incoming message from application(s) through a media server.

The pipeline controller maintains a relation of a related media client pipeline process. The pipeline controller maintains all related states and provides a media client pipeline control interface to the pipeline manager. A pipeline client process is an individual process that uses a uMS connector to provide a control interface to the media server and the like. A pipeline (client) media technology (Gstreamer, Stage Fright) may be decoupled from media server management and services individually and completely.

Meanwhile, ‘image data’ disclosed in the present specification may be used to inclusively mean moving picture data (e.g., video) as well as still image data (e.g., picture/photograph, thumbnail image, capture image, etc.).

In the present specification, a menu is provided in a manner of overlaying an application running screen outputted through a full or main region of the screen by a web launcher or a men launcher (hereinafter named ‘menu launcher) in a webOS loaded digital device.

The menu is configured in a manner of including a first part including history data for a previously watched or run application and a second part listing one or more runnable applications. Here, the second part may provide the application list and also provide a content list related to an application currently provided through a main region. So to speak, the second part may provide at least one of a first mode and a second mode. In the following, the first mode of the second part is described as providing an application list and the second mode of the second part is described as providing a content list. Whether to provide first mode or the second mode to the second in providing a menu launcher may follow settings or be determined according to an application currently provided to a main region. The above determination may be made and provided according to various references such as an application attribute of the main region and the like depending on a user as well as the above-mentioned reference. Meanwhile, the first part and the second part can be called a recent part and a list part, respectively.

Each of the recent part and the list part may include at least one menu item. The menu item may be a unit for sorting, identifying and accessing a content, application, data or the like in each part. And, the menu item may be provided through a window.

Meanwhile, in the present specification, a menu, a recent part, a list part, a menu item or the like is illustrated and described in quadrangular or trapezoidal shape, by which the present invention is non-limited.

FIG. 10 is a diagram showing a screen of a digital device currently outputting an application.

If an application run request signal is received, a digital device 1000 provides a running screen of the run-requested application through a full screen or a main region of a screen.

Here, the application means to include every application of a webOS loaded digital device, and the webOS loaded digital device may call it a web application. The application may include various applications such as a TV (broadcast) application for a broadcast service (e.g., a broadcast program, etc.), an application for an external input, an application for image data and the like. For clarity, FIG. 10 shows an embodiment provided by a broadcast content of a specific channel through a TV application launch.

Meanwhile, the application may be launched through data already stored in a storage medium such as a memory of the digital device 1000 or application data downloaded or streamed from various external servers such as a broadcasting station and the like. In the present specification, ‘application’ and ‘application data’ may be interchangeably usable in some cases. In this case, the corresponding meaning may be determined through a context in a corresponding sentence or paragraph. Besides, in case of a preferred application or a frequently used application, a digital device receives application data using a preload function manually or automatically, thereby enabling a fast access or switching of the corresponding application.

The application running screen shown in FIG. 10 is provided in response to a user's request made through an input means (e.g., a remote controller, a mobile device, etc.) connected to or paired with the digital device 1000. Or, the digital device 1000 can provide the application running screen in response to a signal of a prescribed key button provided to a front panel of the digital device despite not using the above input means. Besides, through the input means or without using the input means, the digital device 1000 can provide various functions, menus and the like as well as the application running screen shown in FIG. 10 based on various input signals such as a voice command, a gesture command and the like. Yet, for clarity of the following description, if an input means is used, it may mean that at least one of all means for a signal or command input (e.g., a key button of a front panel, a voice command, a gesture, an execution command for face recognition, fingerprint recognition, etc., a control command, etc.) to a digital device as well as a case of using the remote controller, the mobile device or the like.

Meanwhile, if an application includes a TV application, it can be processed through the component(s) of the digital device shown in FIG. 2 or FIG. 3. So to speak, IP packet(s) containing a broadcast program or/and signaling data for the broadcast program or a broadcast signal is received through a network interface or tuner and then outputted to a screen finally via a demodulating unit, a demultiplexing unit, an SI decoder, an audio/video decoder and the like. Such a processing process can refer to the substance described with FIG. 2 and FIG. 3 and its details shall be omitted.

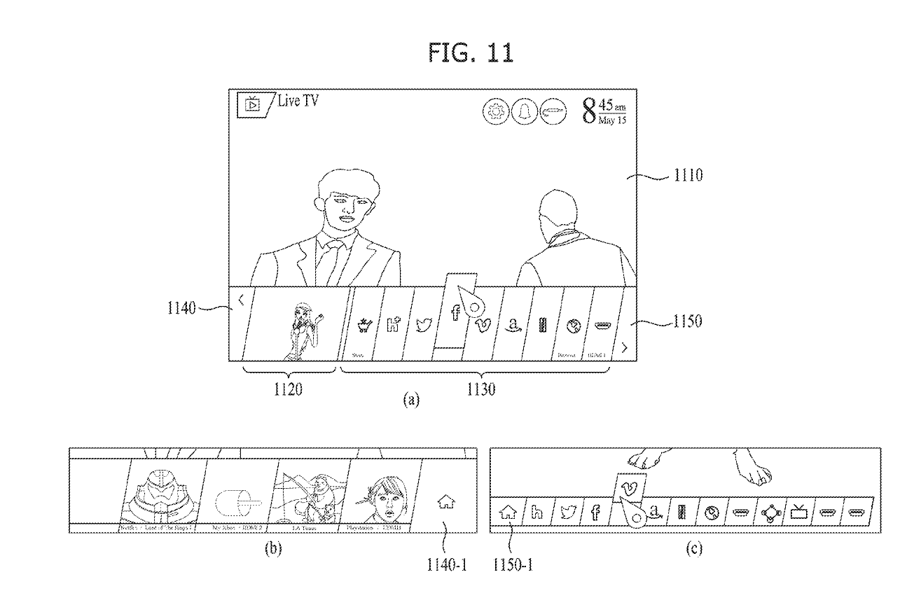

FIG. 11 is a diagram to describe a method of providing a menu in a digital device according to one embodiment of the present invention.

If a signal for requesting a menu is received through an input means in the course of using an application like FIG. 10, a digital device outputs a menu to a current screen in response to the received signal. Although the menu key signal of the input means is not provided, the output of the menu can be provided in a manner of accessing or selecting an icon or a function button provided through a screen using a pointer.

Regarding a digital device of the related art, although a screen is switched overall to output a menu or a considerable or main part of a currently used application running screen is blocked or overlapped by the corresponding screen, it is inconvenient for a user to use a content.

A webOS platform loaded digital device according to the present invention provides the requested menu, as shown in FIGS. 11A to 11C, through a menu launcher. As shown in FIG. 11a, the provided menu is provided to a prescribe region or area of an application running screen currently provided through a full screen. Herein, as shown in the drawing, the prescribed region includes a portion of a screen bottom for example, by which the present invention is non-limited. Meanwhile, a size such as a height or width of the menu launcher (hereinafter, such a size shall be called ‘size’ for clarity), a shape of the menu launcher and the like can be arbitrarily adjusted according to user's settings, application attributes and the like. For example, when an attribute of the currently used application is referred to, if a predetermined data such as a data broadcast or the like is outputted to a screen bottom, the menu launcher may be outputted to a region different from a region shown in FIG. 11a. On the other hand, although the menu launcher is outputted as shown in the drawing, the predetermined data may be outputted to another region failing to overlap the menu output region. This is applicable after outputting the menu. Besides, the menu may be outputted to a prescribed region of a display screen center or one of display screen edge regions. And, the menu may be provided in a manner that two parts are separated and provided to different regions, respectively, instead of being provided to a single region. For example, a first part (recent part) is provided to a prescribed region of a screen bottom, and a second part (list part) may be provided to a prescribed edge region, which is not overlapped, among screen edge regions. Or, FIG. 11a is provided to the screen edge, as shown in the drawing. FIG. 11b and FIG. 11c may be simultaneously provided to left and right edge regions of the screen, respectively. Moreover, if a prescribed part or at least one menu item of the part is selected in FIG. 11a, a function or data related to the selected menu item may be outputted to at least one of the edge regions.

Therefore, if a menu is configured and provided, as shown in FIG. 11a, a screen blocked effect can be minimized in comparison with a related art digital device.

Besides, the menu can change its size based on a position or movement of a pointer. For example, if a pointer is located on a menu, the menu is provided in an original menu launcher size by determining user's intention as a menu control or access. Here, a size of the menu launcher may be a maximum size or not. On the other hand, if the pointer is located not on the menu but on a different region (e.g., a currently used application output region), convenience in using the application can be enhanced in a manner of minimizing a size of the currently used menu launcher or temporarily hiding the currently used menu launcher by determining user's intention as an application control or access. If the menu launcher for providing the menu is temporarily hidden, it is able to notify a user that the menu launcher is already and currently outputted in response to a request. This is to minimize user's inconvenience in calling a menu again or using the menu. In brief, a menu launcher including a menu according to a user's request, an attribute of a currently used application, a position/movement of a pointer and the like can be provided as various versions and can be controlled to change its size and the like. Moreover, as described above, the menu launcher can be controlled automatically or manually after having been outputted.

FIG. 11a shows a digital device that provides a menu launcher including a menu in response to a user's request in the course of using an application 1110 through a main screen. FIG. 1 la may show an initial screen having the menu included menu launcher provided to a screen in response to the user's request.

As described above, a menu provided through a menu launcher can be mainly configured with two parts. A first part 1120 outputs recents data and a second part 1130 includes or outputs an application list or a content list.

To one side of the first part 1120, an interface 1140 for accessing history data related to the first part 1120 or additional history data is provided. The history data means data for an application previously provided to a screen before using an application currently provided through the screen. Hence, if a user selects the interface 1140, as shown in FIG. 11b, the menu launcher can be switched or changed. Referring to FIG. 11b, an interface 1140-1 is provided to the far right and history data are provided in a manner of being arranged to the left side of the interface 1140-1. If a user selects the interface 1140-1 through an action previously determined by the user, a key signal or the like, the digital device switches the screen shown in FIG. 11a again. Hence, the menu launcher is provided by being switched to FIG. 11a from FIG. 11b according to an access to the interface 1140-1. Here, the history data may be provided in a manner of being arranged to the left from the interface 1140-1 on the basis of timeline. Namely, the history data may include data of a recently accessed application if getting closer to the interface 1140-1, and vice versa. Meanwhile, regarding the provided history data shown in FIG. 11b, the history data for a prescribed time can be accessed only in response to a user's request or setting. Besides, history data currently provided in FIG. 11b may include history data of a different time unit, i.e., additional history data according to a position or movement of a pointer. In doing so, the interface 1140-1 may continue to being provided to the corresponding position.

Meanwhile, to one side of the second part 1130, an interface 1150 for accessing an application list related to the second part 1130 or an additional application list is provided. If a user selects the interface 1150, the digital device provides a menu launcher shown in FIG. 11c. An interface 1150-1 is provided to the left side in FIG. 11c, and menu items corresponding to an application are provided in a manner of being arranged to the right side of the interface. Here, the arranged menu items may include menu items corresponding to a currently outputted application in FIG. 11a, or may not. Meanwhile, the application corresponding menu items provided to the second part 1130 of the menu launcher of FIG. 11a may include basic menu items preset according to digital device's settings or user's settings, or may not. Or, the menu items of the second part 1130 of FIG. 11a or the menu items shown in FIG. 11c may be arranged based on user's application preference such as user's application use frequency, user's application use count, user's application use time or the like, an attribute of a corresponding application, or the like.

In FIGS. 11a to 11c, the interfaces 1140, 1140-1, 1150 and 1150-1 may be implemented in other forms unlike the drawings. And, the first part 1120 and the second part 1130 configuring the menu launcher provided in FIGS. 11a to 11c may switch their output positions or regions. Moreover, each menu item within the corresponding part can be moved within the corresponding part or to another part.

In the present specification, ‘access’ or ‘selection’ can be achieved in a manner that a pointer provided to a screen or the like is located in a prescribed region, part or the like during a prescribed time or by at least one of hovering, click, drag, drop and the like. And, the ‘selection’ may be made through separate key button(s) provided to a remote controller or a front panel of a digital device, performed through a voice, gesture or the like, or achieved by the combination thereof. Meanwhile, in the present specification, a remote controller is described by taking a motion remote controller as an example, by which the present invention is non-limited. For example, the remote controller may include another digital device such as a smartphone or the like.

Although FIG. 11a shows that a single menu item is provided in the first part 1120, by which the present invention is non-limited. For example, a plurality of items may be provided to the first part 1120. Meanwhile, each of the menu items can identify an application or content matching the corresponding menu item, contain one or more corresponding image data, or output the image data. Each of the menu items may include image data of automatically capturing a screen in case of ending a currently used application or switching a channel or screen. Hence, if a user selects the first part 1120, a first application (a currently watched application) provided screen is switched overall on a main scree to a second application running screen corresponding to image data of the first part 1120. Instead of the second application image data, a capture image data of a last screen of the first application before the switching or a representative thumbnail image data of the first application is provided to the first part 1120. Meanwhile, the first application currently provided to the main screen may be located in the background in a manner of maintaining a suspended or paused state without ending its playback. Besides, in the above case, the screen may not be switched overall despite the selection. Instead, the screen may be played at the corresponding location as it is or provided in form of PIP (picture in picture), POP (picture of picture), PBP (picture by picture), or the like.

As described above, the second part 1130 of the menu launcher provides an application list. Yet, as shown in FIG. 11a, due to a limited size of a device screen, a list of all application providable or available in the digital device may not be listed at a time through the second part 1130. Hence, as described above, the application list failing to be listed through the second part 1130 is provided through a fourth part 1150 in the manner shown in FIG. 11c. Therefore, the application list provided to the second part 1130 of FIG. 11a can be regarded as selected from the available applications in the digital device. For example, among all available applications in the corresponding device, the applications provided to the second part 1130 of FIG. 11a may be provided in a manner of being sorted by: i) user's settings or request; ii) application recently used by a user; iii) user's use frequency; iv) application related to application currently provided through a main screen; and v) alphabets or consonants/vowels of Hangeul of an application title and the like, or in a manner of taking at least two of the i) to v) as priority factors and being then sorted on the basis of the factor values.

Meanwhile, if a menu item corresponding to a prescribed one of the menu items corresponding to the applications listed on the second part 1130 of FIG. 11a is selected, the application of the selected menu item may be directly run on the corresponding region, provided by replacing the application of the main screen overall, or provided together with the currently used application through screen partitioning. This may be attributed to the attribute of the selected application, or may be implemented through a function or control icon provided around the selected application. According to the screen providing result, the image data of the first part 1120 may be changed. Meanwhile, a location or order of an application on the second part 1120 of FIG. 11a or an application listed in FIG. 11c can be randomly changed or controlled. This equally applies to the history data of FIG. 11b. Namely, a user can arbitrarily control a location or order of timeline based history data.

A menu item selected from each part can be provided by being differentiated in a manner of differing from an unselected menu item in color, having an enlarged size larger than that of the unselected menu item, and the like. Besides, as shown in the drawing, a selected menu item is slightly lifted up, an outline of the selected menu item is highlighted, or separate title data of an application matching the corresponding menu item is outputted under the corresponding menu item. Moreover, at least two of the differentiated substances are combined to provide various configurations to differentiate the selected menu item from unselected menu items.

Like the above description and FIG. 11, by providing a menu launcher together with a currently used application, a user can recognize the menu more intuitively than that of a related art digital device and access a desired application more easily and quickly. While a screen block or change of a currently used application is minimized, a user can use various functions, submenu items and the like of a digital device or application through minimum depth(s) as well as a menu, use convenience is maximized. So to speak, in a digital device according to the present invention, application can be quickly accessed, a fast inter-content switching is possible, and an operation of multitasking and the like can be performed easily and quickly.

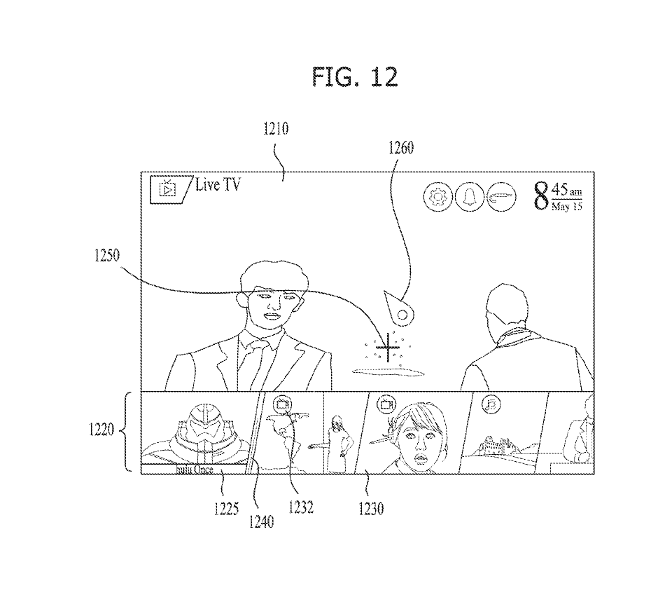

FIG. 12 is a diagram to describe a method of providing a menu in a digital device according to another embodiment of the present invention.

In response to a user's menu request, a digital device can provide a content/application based menu configured like FIG. 12 different from FIG. 11 through a menu launcher.

Referring to FIG. 12, a single application is provided to a main screen 1210, and a menu launcher is provided to a prescribed region of the main screen 1210 by overlaying it.

Unlike FIG. 11, a menu described as below can be categorized into a menu for a present mode, a menu for a past mode, and a menu for a future mode, and a menu launcher configuration for each mode may differ. Such menu mode categorization is to provide convenience in using a menu more intuitively and easily in comparison with FIG. 11.

A past mode relates to a menu configuration for previously used history data, and a future mode may include a menu configuration for a recommended content/application or the like to be used in the future. Meanwhile, as shown in FIG. 11, a present mode means a basic menu provided in calling a menu and may have the meaning of including all menu configurations other than the past mode and the future mode. For example, the present mode may configure a menu by focusing on an application/content frequently used in a digital device.

In the present specification, for clarity of the description, in response to a user's menu request, a digital device may be set to provide a menu of a present move as an initial menu through a menu launcher. In this case, in the digital device, a past mode and a future mode may be entered from the initially provided present mode, by which the present invention is non-limited. For example, if a user fails to request a menu of a specific mode, a digital device provides at least one of a past mode and a future mode through a menu launcher according to user's settings or various associated factors. Yet, for clarity of the following description, a menu launcher of a present mode is provided as a basic or default menu and a past or future mode is accessed from the present mode is taken as one example for description. Yet, regarding the present invention, a scenario for a mode switching, a mode entry or the like can be configured in various ways without being limited by the illustrated and escribed substances in the present specification.

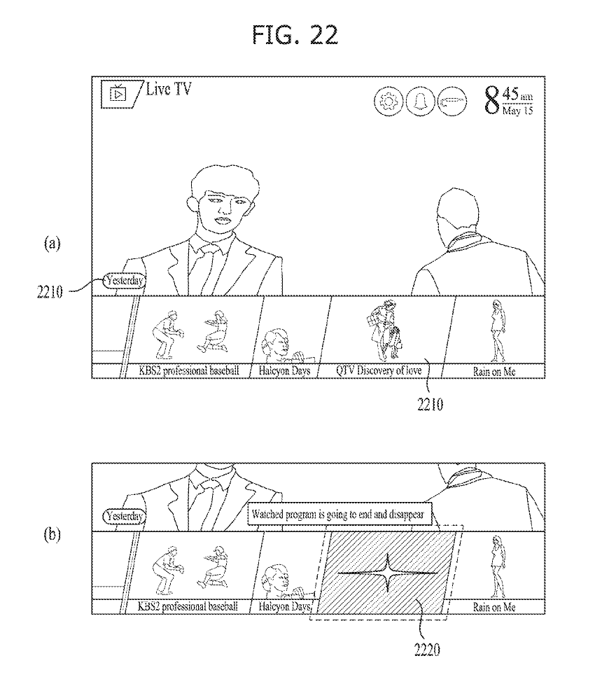

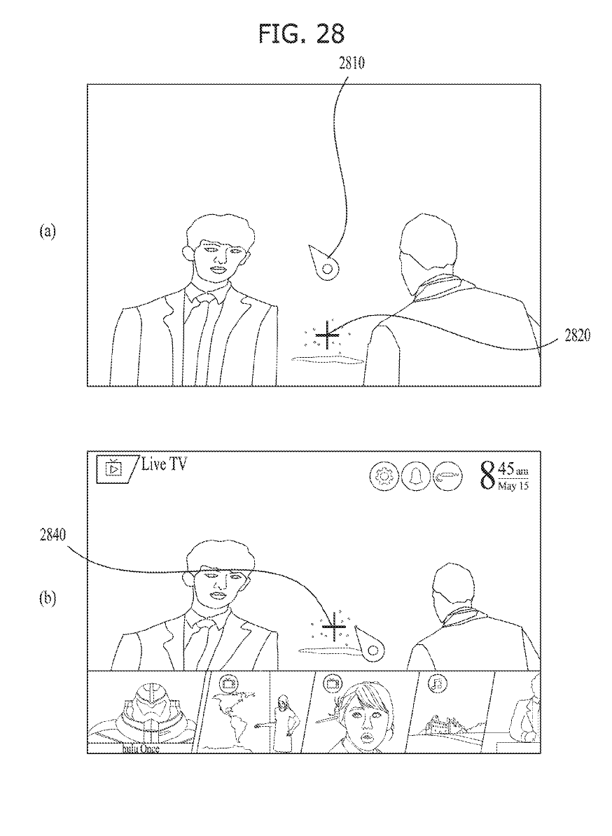

FIGS. 12 to 21 show a menu launcher of a present mode menu, FIGS. 22 to 27 show a menu launcher of a past mode menu, and FIGS. 28 to 35 show a menu launcher of a future mode menu. They are described in detail with reference to the accompanying drawings as follows.

First of all, FIGS. 12 to 21 are diagrams to describe a menu configuration of a present mode menu in detail.

Referring to FIG. 12, as described above, a menu launcher may include a recent part 1220 and a list part 1230. Here, the menu launcher may further include an interface part 1250 for future mode entry. And, the menu launcher may further include an interface for accessing a history data list, related function and data of the recent part 1220, an interface for accessing an additional application list, related function and data of the list part 1230, and the like. Meanwhile, for clarity, the list part 1230 is configured in a second mode, i.e., a content list.

A menu in a present mode is provided in a manner that the recent part 1220 and the list part 1230 are discriminated from each other with reference to a reference indicator 1240.

The recent part 1220 corresponds to the first part shown in FIG. 11, i.e., the aforementioned recent part and contains history data. In the present mode, history data for an application used right before an application currently provided to a screen may be outputted only. Here, as the history data, the recent part 1220 may provide at least one of various data such as image data of a corresponding application, a title data 1225, a server data, an icon and the like. For example, the image data may include one of a representative thumbnail image, an image data captured right before switching to a currently provided application, an image data downloaded from a server, and an image data saved to a digital device. Moreover, if a plurality of image data or history data for a corresponding application exist, they can be provided within a corresponding menu item in form of a slide show.

If receiving a selection signal of the recent part 1220, the digital device plays an application included in the recent part 1220, i.e., a previously run application in a manner of switching it to an application currently provided through a main region. In doing so, the play may start in continuation with a previously play stopped part or start from the beginning again. Meanwhile, if the switched application is a real-time application (e.g., a ral0time broadcast program), a user is guided to select a previous play stop timing or a point to be played in data at a current time and the corresponding selection may be followed. Or, although not shown, as described above, if the recent part 1220 is selected or a pointer 1260 is located within the recent part 1220, the digital device may provide a play icon (a reproducing icon) for a play of a corresponding application or detailed information on a corresponding content. Or, although not shown, if the recent part 1220 or the like is selected, as described above, a corresponding application can be run within the corresponding recent part 1220 without affecting an application currently run in the main region instead of being switched and played. In this case, by providing a play bar for the playback, the digital device may further provide data such as a current play position, a play end time, a time left to the play end and the like.

Meanwhile, if receiving a signal of selecting title data, server data or the like within the recent part 1220 through the pointer 1260, the digital device may provide an application related to the title or server data or guide data for a server access related to the application through a screen or browser. Here, the guide data or the browser is overlaid but can be provided at a most upper level on the screen.

The digital device may provide additional or related data in form of a menu icon in the recent part (1220) selection or access process in the aforementioned description. Yet, it is non-limited by the icon form provision scheme only.

Besides, in the present specification, the data for one application is provided by the recent part 1220 for clarity, which is just one example only and by which the present invention is non-limited.

Meanwhile, the aforementioned recents part is related to a past mode that will be described later. Yet, related details are omitted here but shall be described later.

In the above description, the reference indicator 1240 plays a role as a reference for discriminating the recent part 1220 and the list part 1230, i.e., a boundary role. For example, as described above, since the recent part 1220 outputs one recent data only, it is not scrolled to the left/right or the like. Yet, list part data can be scrolled to the left/right according to the number of the list part data. The list part data is configured with reference to the reference indicator 1240 and the recent part 1220 can continue to be provided at the corresponding location without being affected by the scroll. Moreover, if the menu launcher has a multi-step configuration instead of a single-step configuration with reference to top- to-bottom reference, as shown in the drawing, the reference indicator 1240 may perform a scroll function.

As described, the list part 1230 provides one or more menu items for an application. In doing so, the menu items are arranged for the list part of the present mode according to various references for example. The various references may mean at least one of settings of a user or digital device, a recently launched application order, a running time, a running count, a running frequency, an attribute and the like for example.

Each of the menu items, as shown in FIG. 12, may include an icon data 1232 for a corresponding application. Here, each of the menu items may further include image data, title data and the like for the application. Here, the image data may include representative thumbnail image data for the corresponding application for example. Meanwhile, various data provided to the menu item is provided only if a signal for the corresponding menu item is received. Or, the various data may be provided according to an access of an adjacent menu item.

As describe above, although the list part is not shown clearly, the list part provides a scroll bar. Hence, additional application menu items can be accessed with reference to the reference indicator 1240 without a change of screen configuration.

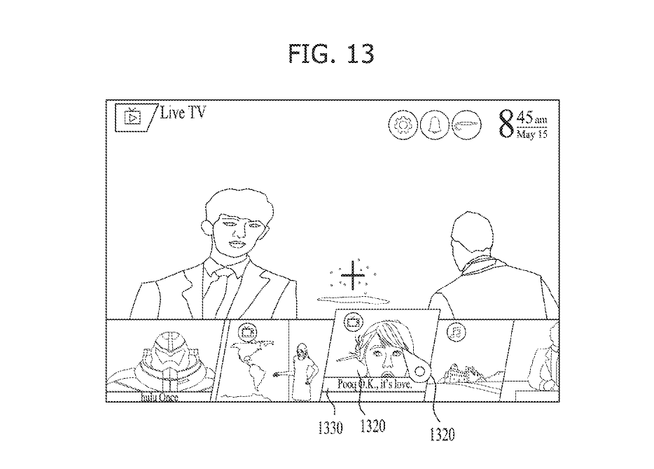

One embodiment of controlling a list part of a menu launcher is described with reference to FIG. 13 as follows. Here, the list part of FIG. 13 is configured in second mode.

If receiving a signal of selecting a prescribed menu item belonging to a list part, as shown in FIG. 13, a digital device provides a menu item selected first in a manner that such a selected menu item is discriminated from unselected menu item(s). In FIG. 13, the corresponding menu item is lifted up higher than an unselected menu item. The selected menu item provides data for an application unlike the unselected menu item(s). In FIG. 13, server data (e.g., Pooq) of a corresponding application and title data (e.g., O.K. it's love) are provided. Yet, the digital device can further provide additional data as well as the illustrated and described data or provide other data. In the above description, the server data means data for a server that provides or services a corresponding application data.

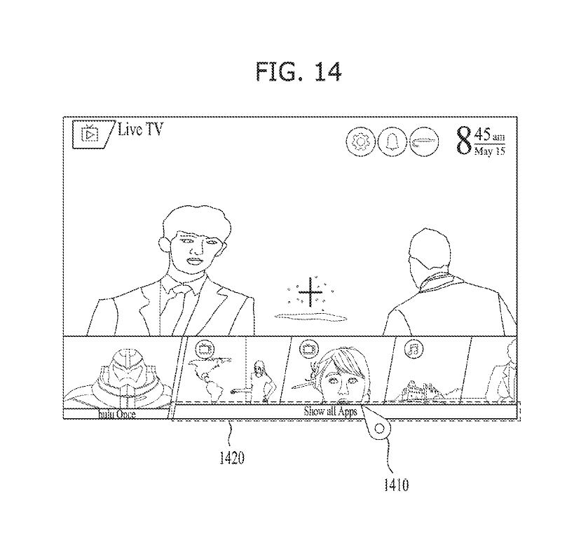

With reference to FIG. 14, another embodiment of controlling a list part of a menu launcher is described as follows.

In FIG. 14, a list part is still provided by being configured in second mode in continuation with FIG. 13. Yet, as described above, according to the present invention, a list part can be provided by being configured in first mode as well as in the second mode of providing an application/content list related to an application/content currently provided to a main region. As described above, the first mode includes an application list providable or runnable in a digital device irrespective of an application or content currently provided to the main region. So to speak, a first mode of a second part provides an application/content list irrespective of an application/content currently run in a main region but a second mode provides a related application or content list.

When a digital device provides a menu launcher, it is difficult for a user to directly identify whether the second part is provided in first or second ode. Hence, after the menu has been provided, it may be required to switch a mode of the second part easily and conveniently. According to FIG. 14, if a pointer 1410 is located in a prescribed region (e.g., a bottom region of a list part) within the list part, an interface 1420 for mode switching shown in FIG. 14 can be provided.

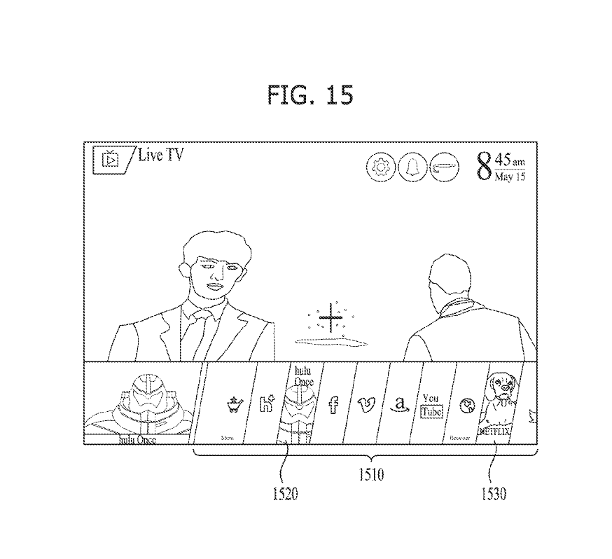

Here, if receiving a selection signal of the mode switching interface 1420, the digital device provides the second part in a manner of switching a mode from the second mode in FIG. 14 to the first mode in FIG. 15.

Referring to FIG. 15, the second part provides an application list 1510 providable or runnable in the digital device in the first mode. Here, each menu item of the application list 1510 provided in the first mode includes data for identifying a corresponding application for example. One or more menu items 1520 and 1530 in the application list 1510 provided in the first mode, as shown in FIG. 15, may include image data for a corresponding application on behalf of or together with the corresponding application identification data. For example, the image data is image data captured on ending a previous running or representative thumbnail image data of the corresponding application, and may be received from a memory of the digital device, a server or web server providing the corresponding application, or the like. Here, as described above, an application list having no image data may include an application that has never been run or an application that has not been run recently for example.

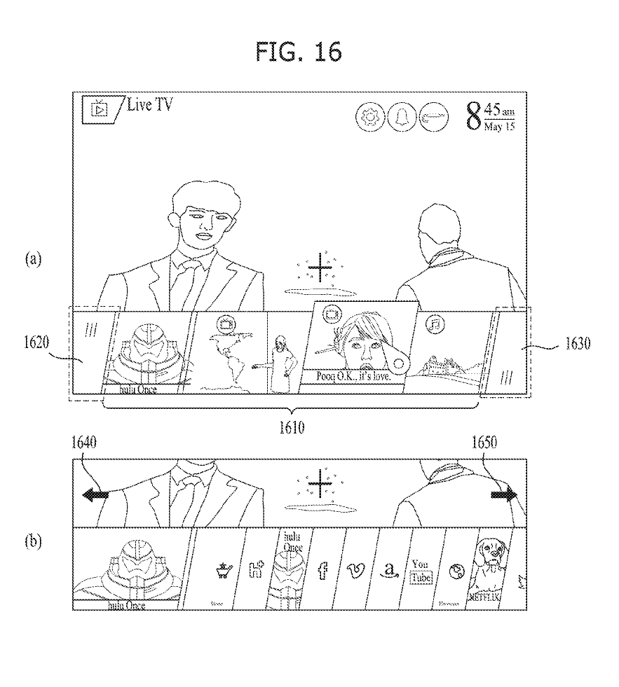

FIG. 16a shows a menu configuration similar to that of FIG. 11a . so to speak, interfaces 1620 and 1630 for accessing an additional menu item are provided to one sides of first and second parts, respectively. here, the second part is provided in second mode.

FIG. 16b shows an interface different from that of FIG. 16a. In FIG. 16b, interfaces 1640 and 1650 in arrow shape are provided to perform the same functions of the interfaces shown in FIG. 16a. Although FIG. 16b shows that the interfaces 1640 and 1650 are provided to regions failing to overlap the menu launcher, they may be provided to the locations in FIG. 16a depending on an implementation example

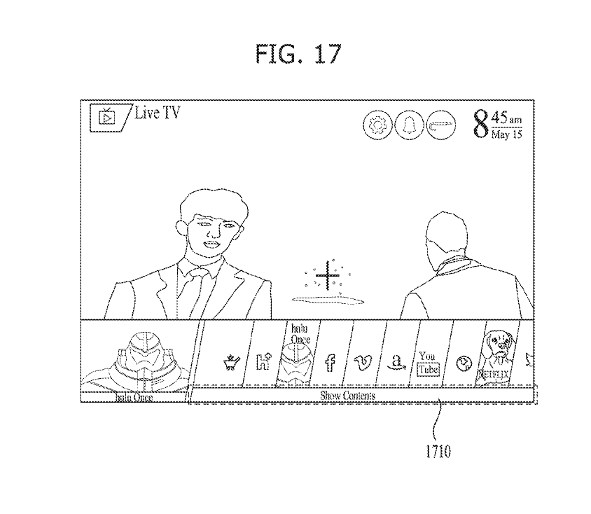

FIG. 17 shows another embodiment for the aforementioned mode switching of the second part. FIG. 17 shows an example of switching to a second mode from a first mode, whereas FIG. 15 shows the switching to the first ode from the second mode. So to speak, if a pointer is located at a prescribed region in a first mode of a second part of a menu launcher, and more particularly, at a bottom edge side, a digital device provides an interface 1710 for a mode switching. If the mode switching interface 1710 is accessed, the digital device changes a second part configuration from an existing mode (first mode) to another mode (second mode).

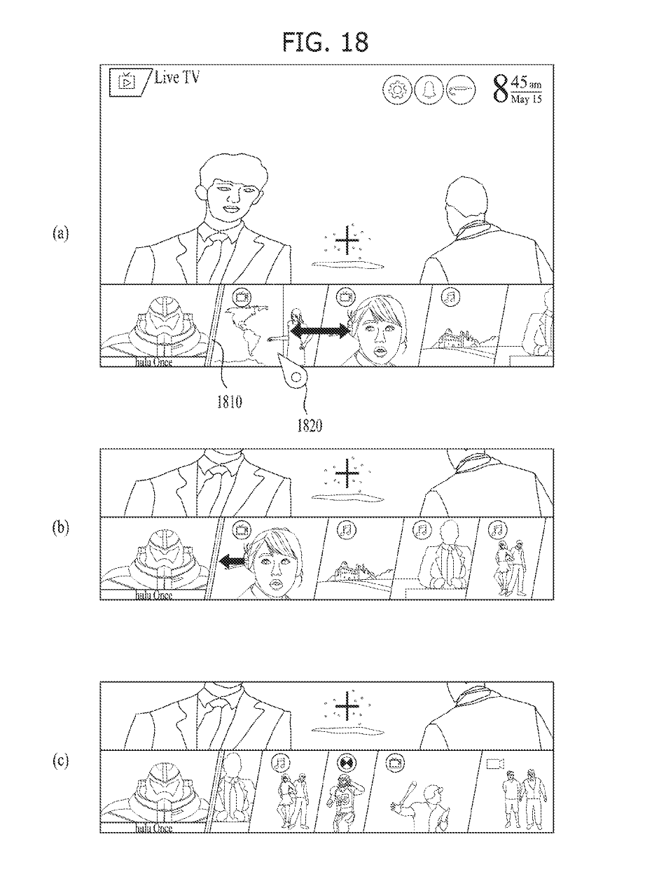

Referring to FIG. 18, a menu includes a first part and a second part. The second part provides a second mode, i.e., an application list or a content list. As described above, such an application/content list includes an application/content related to an application/content currently provided to a main region.

Referring to FIG. 18a, a digital device shows that it is able to scroll a list in a second part right and left. Hence, as shown in FIG. 18b and FIG. 18c, if a scroll is performed to the right, it can be observed that a menu item for an application is scrolled with reference to a reference indicator 1810.

The scroll in FIG. 18 may be performed by a navigation key button signal provided to an input means such as a front panel or a remote controller or according to a location or motion of a pointer.

Meanwhile, if a pointer is located at a menu item, the digital device may perform an operation for a control of the corresponding menu item [not shown]. For example, if a pointer selects a menu item and is located on an edge of the selected menu item, the digital device can change a size of the corresponding menu item top and bottom or right and left. For example, if the pointer is located on a right edge of the selected menu item, as shown in FIG. 18a, an icon for a right-to-left size change is displayed or a shape of the pointer is changed. And, a size of the corresponding menu item can be changed according to the selection. If there is a size change, the digital device may further provide data more detailed than that of a menu item in original size or various data such as a function icon, a recommended content/application and the like on the menu item in the changed size. Or, it is a matter of course that a size of a menu item can be enlarged only.

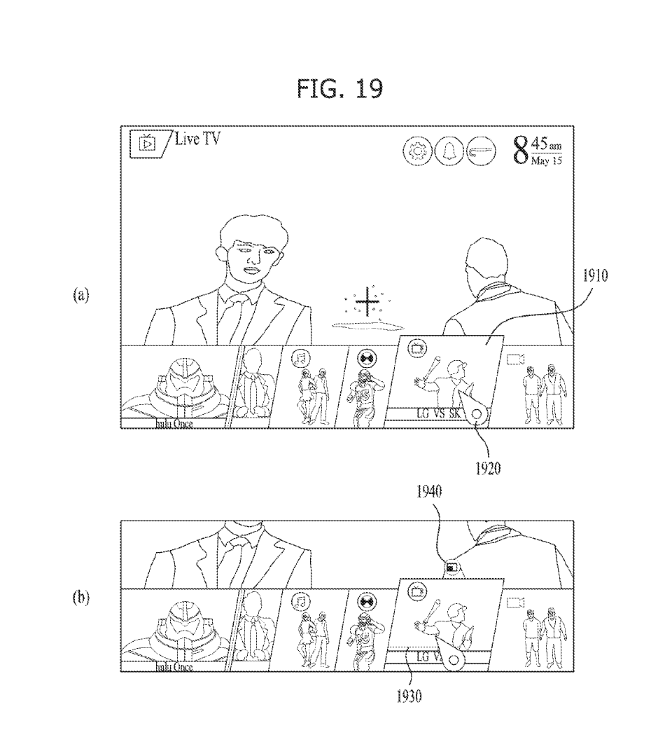

FIG. 19 is a diagram showing a play control of a selected menu item in the aforementioned substance.

Referring to FIG. 19, if a pointer 1920 is located at a menu item 1910 of a second part [FIG. 19a], a digital device switches to a full screen so as to play it in form of PIP within a corresponding window without running an application of the menu item 1910 [FIG. 19b1. In doing so, referring to FIG. 19b, the digital device provides a paly bar 1930 within the menu item so as to control a position or play of a currently running part. The digital device may provide the play bar 1930 together with various function icons for the play control [not shown in FIG. 19b1.

Moreover, as described above, although FIG. 19 shows that an application is played on a window that provides a selected menu item, if a user desires to enlarge and play the application by switching to a full screen, a switching icon 1940 for the same can be further provided.

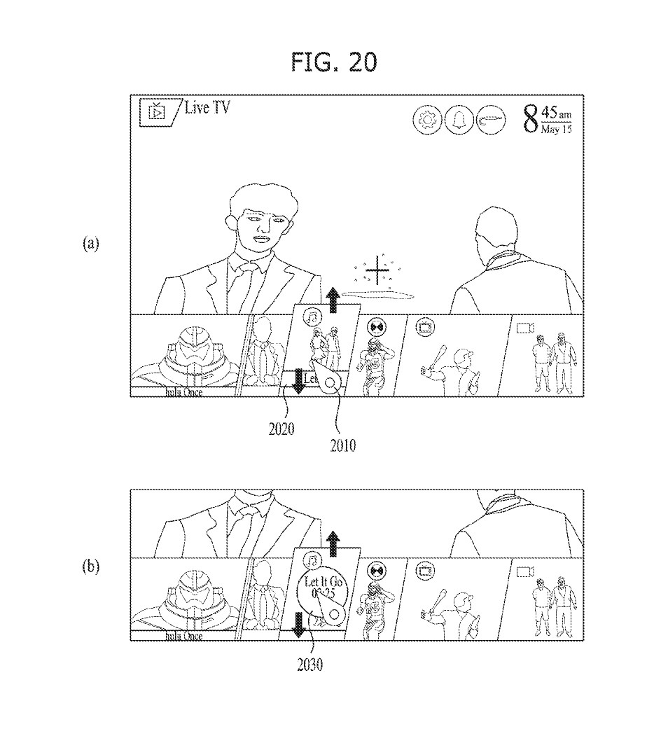

FIG. 20 is a diagram showing a control of a selected menu item.

If a menu item is selected and the selected menu item is then moved in a top or bottom direction [FIG. 20a], a digital device can play an application of the menu item like FIG. 20b. For example, in response to a top-directional movement in FIG. 20a, an application is played like FIG. 20b. On the contrary, if the menu item is moved in a bottom direction, a playback of the currently played application can be ended.

Or, while an application (e.g., MP3 application) of a menu item is currently played in FIG. 20a, if the menu item is moved in a top or bottom direction, a next or previous song can be entered and played in direct.

As shown in FIG. 20a and FIG. 20b, for a play control of a corresponding application, if a corresponding menu item is selected and then shifted in a top or bottom direction, the play control is enabled. Yet, if the menu item disappears in a bottom direction, i.e., below a screen, the menu item for the corresponding application may be set to disappear from the list. Or, a play file of the corresponding application may be defined to be removed only.

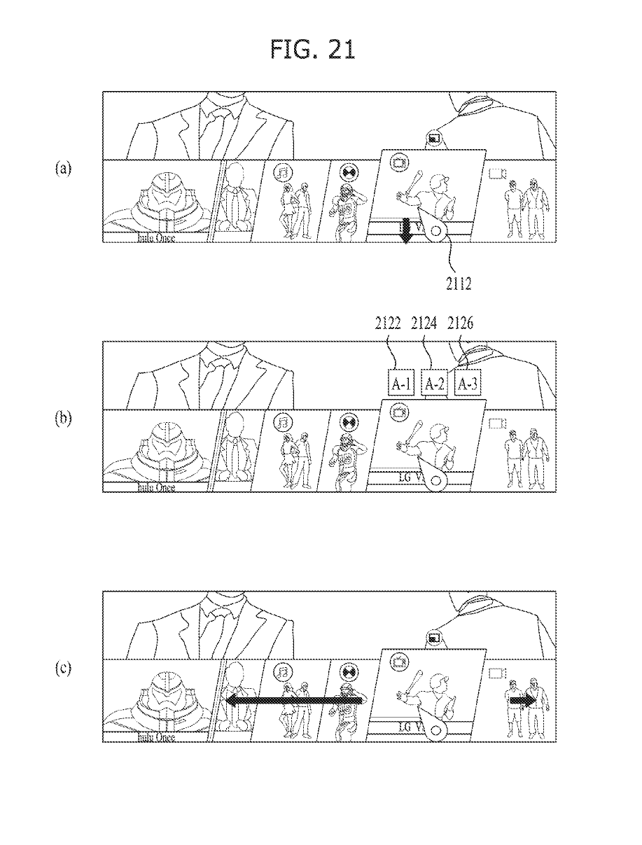

If a menu item of a second part is moved in a screen bottom edge direction [FIG. 21a], play related icons 2122, 2124 and 2126 can be provided around the corresponding menu item (e.g., top end of the corresponding menu item, etc.). The play related icons 2122, 2124 and 2126 may include a recommended content/application, a function icon for a corresponding application play control, a preview image of the corresponding application, and the like.

Meanwhile, in FIG. 21c, a selected menu item can be shifted not to a bottom edge but to a right/left edge. If the selected menu item is shifted right and left, the digital device can set the corresponding menu item to be located between different menu items.

In the following, as described above, a menu launcher configuration of a past mode menu, a control of the past mode menu and the like are described in detail with reference to FIGS. 22 to 27.

With respect to a past mode, a corresponding entry can be achieved in various ways. A past mode entry can be performed in various ways. For example, the past mode entry can be performed in a manner of accessing a recent part or an interface or part (e.g., the first part 1120 or the third part 1140 in FIG. 11) for checking details of the recent part. If the first part 1120 is accessed, for example, UI data for guiding that the past mode is entered may be provided. Or, when an initial menu is provided, as shown in FIG. 11 or FIG. 12, menu items or icons for entering a past mode, a present mode and a future mode are provided. And, the past mode entry can be enabled according to a selection of such a menu item or icon [not shown in the drawing].

A scenario after a past mode entry is described in detail as follows.

Referring to FIG. 22a, a past mode, i.e., history data is provided in a manner of being arranged in order of previously used time. In FIG. 22a, for example, toward a left side with reference to a right edge of a menu launcher, it can be observed that a used time of an application/content gets earlier.

Meanwhile, in FIG. 22a, arranged applications are provided by being grouped by date unit (e.g., yesterday 220). Yet, this may be arranged according to a different reference depending on the number of applications to be provided in the past mode. For example, in FIG. 22a, within the date (yesterday 2210) reference, applications can be identifiably provided by being sorted by time unit, minute unit, second unit, or the like. Moreover, the applications can be provided by being sorted by at least one of application/content attribute, application/content image quality, application/content provided channel, leading player and the like in application/content, presence or non-presence of application/content series, presence of non-presence of application/content use completion, presence or non-presence of application/content real-time data/streaming, application/content capacity and the like as well as time references such as date, day of week, etc. meanwhile, at least two of the above-mentioned references may be used for application arrangements by being combined together.

Referring to FIG. 22b, like FIG. 22a, when a currently used application among arranged applications is a real-time application, a time-limited application or the like for example, if a use is ended, the corresponding application may be removed from an application list of the past mode [2220]. In doing so, the digital device may also provide guide data so as to indicate that a corresponding menu item is removed from the application list of the past mode due to the end of viewing. In the above description, it is mentioned that the guide data is provided when the application is removed from the list. Instead, by providing the guide data in advance before the removal, i.e., ahead of a prescribed time of the application/content use end of the corresponding menu item, it is able to guide a user to take an additional action or the like. Yet, the guide data may be provided only if a past mode is executed. Thus, the guide data is provided because of the following reason. Namely, after an application/content of a corresponding menu item has been removed from a list, since it is difficult to access such an application/content, it is intended to guide a user to use such functions as instant recording/reserved recording, time-shift, etc. Thus, in case of a real-time application, after checking whether an associated data is recorded by accessing a VOD server, an internet server or the like, alarm data may be provided.

In present, past and future modes, various functions such as EPG/ESG data calling, instant/reserved recording, reserved viewing and the like may be used in direct through menu items [not shown].

Besides, while a past mode is used, if there is a previously provided history data, i.e., an update item (e.g., modification, alteration, etc.) of prescribed data for menu items, a digital device can identifiably provide it to a corresponding menu item or a prescribed region of a screen.

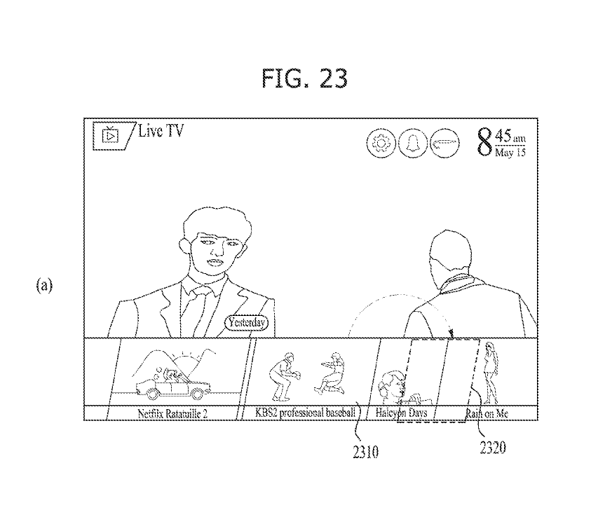

FIG. 23 is a diagram showing an embodiment of controlling a menu item in past mode.

Referring to FIG. 23, as described above, menu items are provided by being arranged according to viewing time.

In doing so, a position of a menu item 2310 for a previously viewed KBS2 professional baseball broadcast service application among the arranged menu items can be shifted within a past mode. For example, the menu item 2310 can be located between Halcyon Days application menu item and Rain on Me application menu item, which are arranged as viewed ahead of the menu item 2310. If a position of the prescribed menu item 2310 is shifted, as shown in FIG. 23, menu items included in the past mode related to the menu item may be provided by being arranged around the corresponding menu item or a function icon related to the corresponding menu item and the like may be provided.

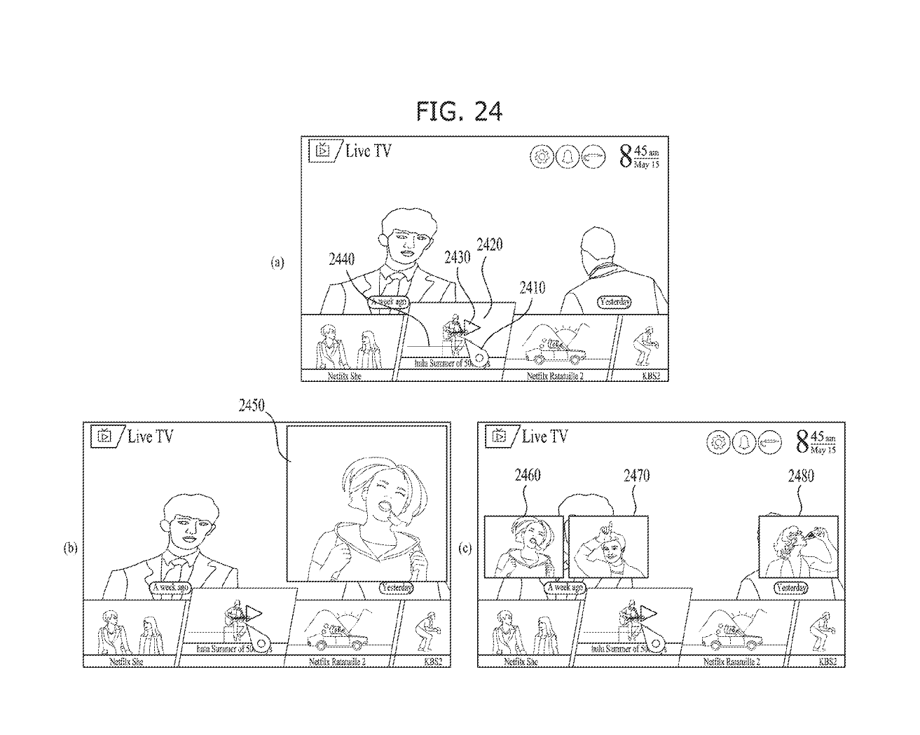

FIG. 24 is a diagram to describe an application processing method in past mode.

Referring to FIG. 24a, as described above, a past mode is provided in a manner that menu items for previously viewed applications are arranged. In doing so, each of the menu items is provided in a manner that an image right before the viewing end is captured and provided on the corresponding menu item.

If a selection signal of a menu item 2420 is received through a pointer 2410, a digital device slightly lifts up the corresponding menu item 2420 so as to indicate that the item 2420 is selected and then outputs at least one of a play icon 2430 and a play bar 2440 on the menu item. In doing so, if a selection signal of the play icon 2430 is received, the digital device may play a corresponding application in continuation with a previous paly part on a main region or a corresponding menu item window.

FIG. 24b and FIG. 24c show embodiments of providing a multi-view screen through a menu item access for a past mode for example.

Although FIG. 24a shows an embodiment that if a menu item is accessed, an application of the menu item is directly played on a corresponding window or the application of the menu item is played as a full screen on behalf of an application currently played on a main region, FIG. 24b or FIG. 24c shows that the application of the menu item is run on a PIP window or a partitioned screen.

FIG. 24b shows an embodiment that an application of a selected item is provided through a PIP window 2450. In FIG. 24c similar to FIG. 24b, one or more PIP windows 2470 and 2480 for running applications related to a PIP window 2460 are further provided as well as the PIP window 2460 for running an application of a selected menu item.

Unlike FIG. 24a, referring to FIG. 24b or FIG. 24c, while disturbance in using a currently used application is minimized, another application can be used.

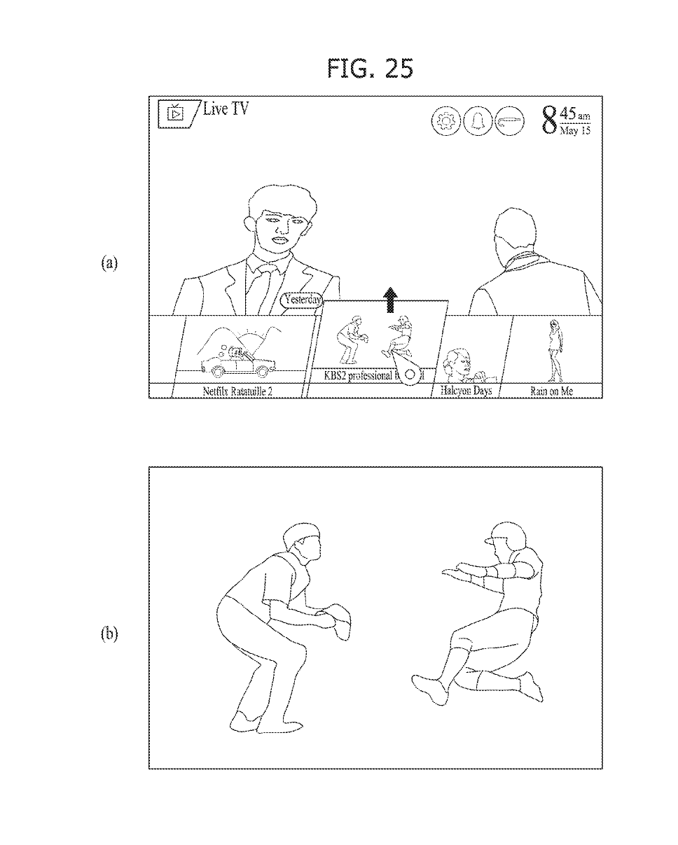

FIG. 25 is a diagram to describe an application processing method in pas mode.

Unlike FIG. 24, after a menu item corresponding to a previously used application of a past mode has been selected through a pointer, if the selected menu item is moved to a main region in which a currently used application is provided through a full screen [FIG. 25a], an application of a menu item is provided through a full screen [FIG. 25b]. In doing so, referring to FIG. 25b, a currently provided menu launcher in past mode can be hidden or ended.

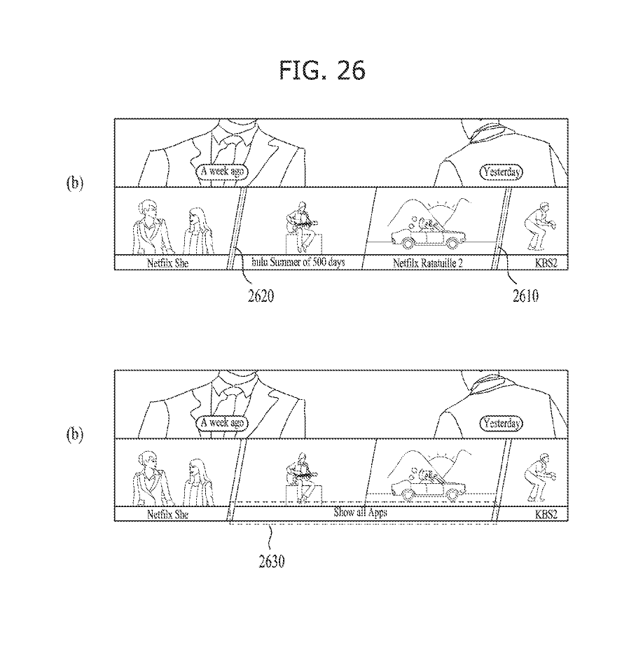

FIG. 26 is a diagram to describe a method of controlling a menu launcher in past mode.

Referring to FIG. 26a, a menu launcher of a past mode is configured and provided. Menu items are provided in a manner of being grouped by use time references 2610 and 2620. Each group provides guide data (e.g., yesterday, a week ago, etc.) so as to be identifiable.

Yet, in configuring a menu of a past mode, referring to FIG. 26a, the menu can be provided in a manner of being configured with a TV service application only.

In this case, if a user requests past mode data for other applications such as game, web browser, HDMI and the like as well as a TV service application, such applications can be provided as shown in FIG. 26b.

If a pointer is located on a prescribed bottom region of the currently provided menu launcher [FIG. 26a], a digital device provides a menu item switching interface 2630 in a manner similar to a control scheme in present move [FIG. 26b].

If the menu item switching interface 2630 of FIG. 26b is accessed, the digital device provides a menu item for a past mode by reconfiguration or switching in a manner of excluding or including menu item of the TV service application previously provided in FIG. 26a.

Although FIG. 26b shows that the interface 2630 for controlling menu items between yesterday and a week ago is provided according to a position of a pointer for clarity, as described above, the whole data of the past mode can be implemented switchable irrespective of the position of the pointer.

Meanwhile, in configuring a menu of a past mode, if there are many history data of the past mode, a group icon may be provided only unlike the former description [not shown in the drawing]. Such a group icon may include ‘a week ago’, yesterday’ or the like in FIG. 26 for example. Or, it is able to provide a single menu item for a single representative application in each group icon only. In the former or latter case, if a prescribed group icon selection signal is received, the digital device may unfold to provide menu items belonging to the selected group.

A menu configuration scheme described in the present specification may follow user's settings or be determined by a digital device for example. In the latter case, the determination can be made using various references such as user data, use pattern, time, date, day of week, weather and the like or by combining the references appropriately.

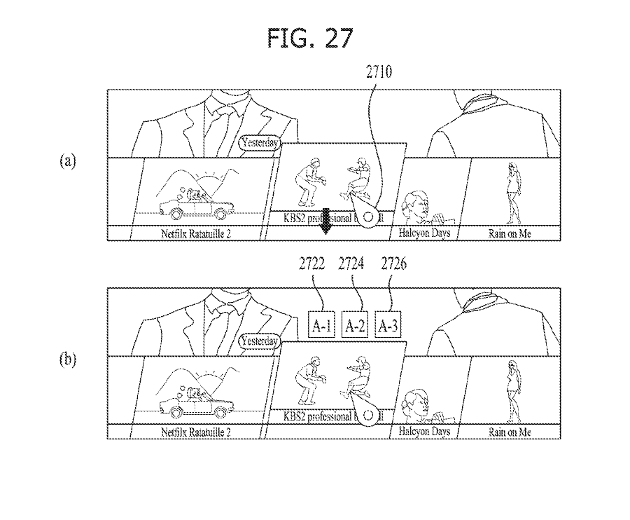

FIG. 27 is a diagram to describe a method of controlling a menu launcher in past mode.

As described above, even in past mode, a menu item can perform a prescribed function by being moved in top, bottom, right and left directions.

If a prescribed menu item 2710 is selected through a pointer and the selected menu item is dragged to move in a bottom edge direction of a screen [FIG. 27a], a digital device provides data 2722, 2724 and 2726 related to the selected menu item [FIG. 27b].

The related data 2722, 2724 and 2726 may include a function icon for performing a prescribed function for an application of the menu item, an application related to the above application, a preview image (previously viewed part included) for the application, and the like. For example, if the selected menu item relates to a baseball broadcast content, the related data 2722, 2724 and 2726 may include a baseball broadcast content of another channel

Finally, a menu configuration and control of a past mode is described in detail with reference to FIGS. 28 to 35.

FIG. 28 is a diagram to describe a method of entering a future mode menu for example.

As describe above, a future mode menu may be entered by accessing an interface 2820 for a future mode entry provided separately from a menu launcher through a pointer 2810 [FIG. 28a] or through an interface 2840 for a future mode entry provided together with a menu launcher of a present mode (past mode included) provided according to a menu calling [FIG. 28b].

The future mode entry interface 2820 may be provided without a present mode menu in case of a menu calling like FIG. 28b but can be directly provided to a screen in response to a key button signal of a remote controller without the menu calling. Meanwhile, FIG. 28a shows that the future mode entry interface 2820 is provided to a middle bottom end of a screen, by which the present invention is non-limited. Hence, the future mode entry interface 2820 can be provided to various positions on the screen. Besides, a shape of the future mode entry interface 2820 is non-limited by the shape shown in FIG. 28a but can be configured in various shapes.

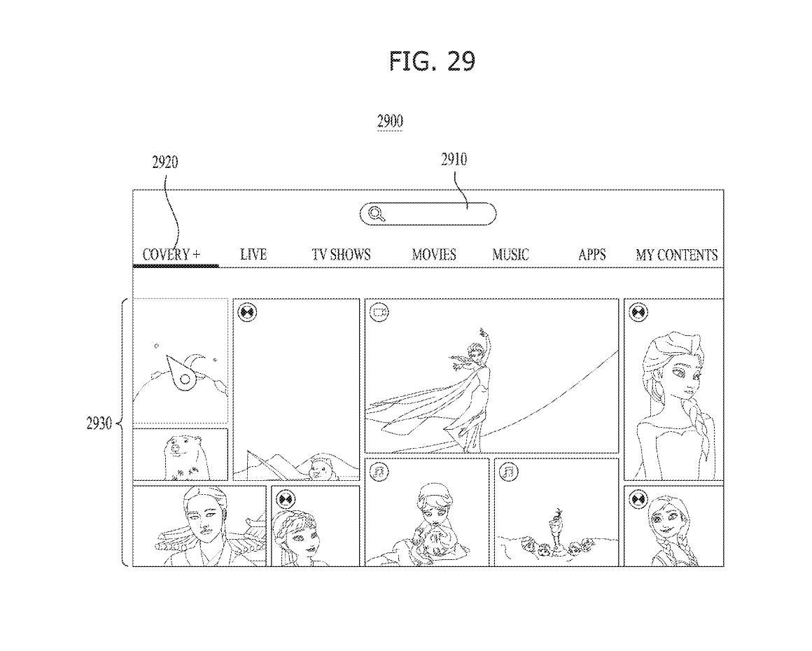

If a selection signal of the future mode entry interface 2820/2830 is received [FIG. 28], the digital device configures to provide a future mode menu [FIG. 29].

A future mode means a menu configuration for recommendation and the like for an application/content not used by a user yet or an application/content having high availability.

In future mode, recommended applications/contents can be provided by being sorted by categories. Such categories may include a basic category, a live category, a TV shows category, a movies category, a music category, a recommended applications (Apps) category, a my contents category and the like. Embodiments of menu configurations for the respective categories are shown in FIGS. 29 to 35, respectively. Meanwhile categories of future mode menus are non-limited by the above description and can be implemented in various ways according to user's settings and the like. Moreover, menu configurations of categories may be implemented different from each other in consideration of property of the corresponding category and the like.

Referring to FIG. 29, a future mode menu includes a search region 2910, a category region, and a recommended content region 2930 corresponding to a selected category. Particularly, applications/contents belonging to the basic category are listed on the recommended content region 2930.

The basic category of FIG. 29 can list all recommended contents or recommended applications/contents selected according to various references. Hence, the former case may be redundant with a recommended application/content of another category. Meanwhile, the arrangement order in the basic category may follow settings such as a category order, a priority order and the like. With respect to the latter case, for example, the various references may include season, weather, time, identified user, recently used application/content attribute, type, pay/free, etc. For example, referring to FIG. 29, applications/contents, which are selected and recommended on the basis of a current season (e.g., winter) or weather (e.g., snowy weather) in an enabled future mode, are listed. So to speak, according to the embodiment shown in FIG. 29, applications/contents usable and popular in snowy winter are listed.

Meanwhile, one or more applications/contents selected from the recommended applications/contents listed in FIGS. 29 to 35 may be played by switching to a full screen according to a corresponding selection or provided in form of PBP (picture by picture) (e.g., partitioned screen), PIP (picture in picture), POP (picture of picture) or the like by maintaining a current future mode menu.

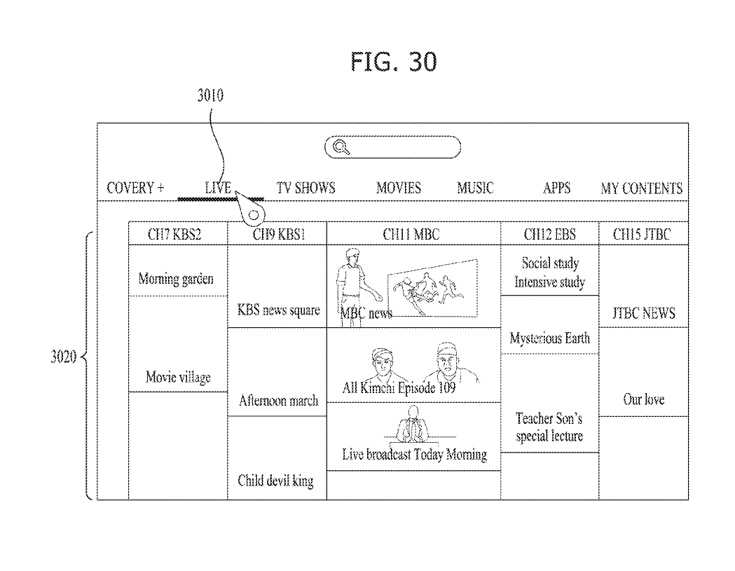

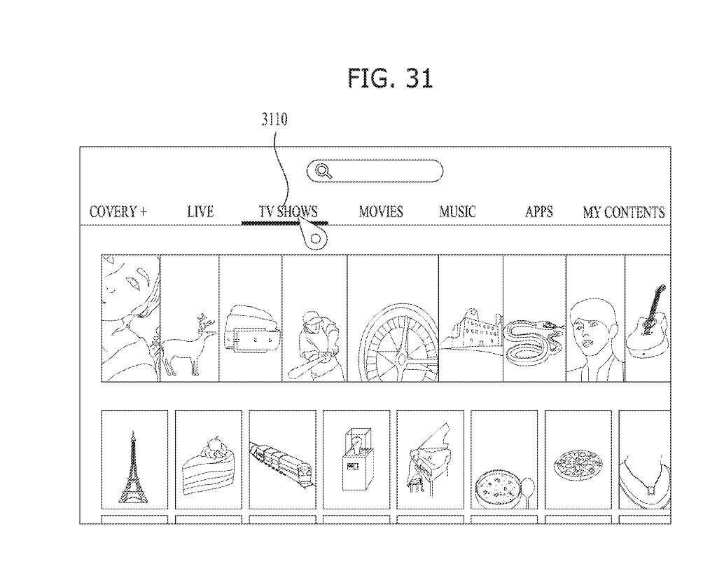

FIG. 30 shows that a live category 3010 lists applications/contents according to a live category 3010. FIG. 31 lists recommended applications/contents according to a TV show category. Here, both FIG. 30 and FIG. 31 show categories related to a TV service and a TV service application. Yet, FIG. 30 shows that EPG/ESG data for broadcast contents to be broadcasted later with reference to a current hour, whereas FIG. 31 shows that VOD contents are mainly provided.

If a menu item is selected from the provided guide shown in FIG. 30, instant recording/reserved recording can be directly performed in future mode [not shown in the drawing]. If a prescribed menu item is selected in FIG. 30, a current screen may be switched to a full screen or a preview image and the like may be provided within a window having a current menu item provided thereon. This is identically applicable to a case of a reserved viewing or the like. In the course of using a future mode, if it becomes a live broadcasting time of previously provided menu items or it is a case by a reserved viewing, the selected menu item may be removed from the future mode or executed on a corresponding window as it is. In this case, after a reserved viewing or the like has been set, when another category or menu is used, a full screen may be used or a playback may be performed on a corresponding window after automatically executing a live category of a future mode. Moreover, in each of the above-mentioned cases, guide data for use convenience or identification convenience may be provided.

As described above, FIG. 31 may show a VOD recommendation list for one embodiment. In this case, a free VOD content and a pay VOD content can be provided by being discriminated from each other. Moreover, VOD contents may be listed by being sorted by a VOD content providing server unit or a type or attribute unit of VOD content.

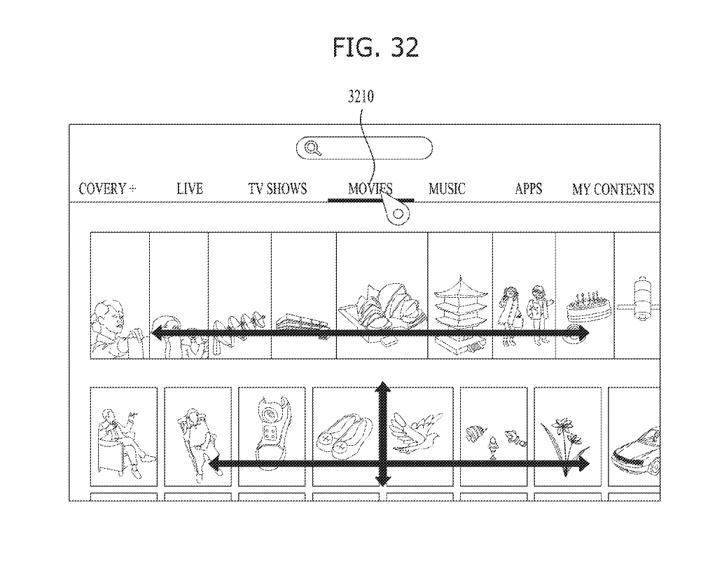

FIG. 32 shows that a recommended application/content list belonging to a move category 3210 is provided. The recommended application/content list belonging to the move category may include a list of VOD movies or a list of movie contents unused yet despite being saved to a digital device. Or, a recommended application/content belonging to the movie category may include a content to be provided on a movie dedicated channel or the like among one or more channels belonging to a TV service. As shown in FIG. 32, it is apparent that positions of menu items corresponding to a recommended application/content provided in future mode can be moved in any directions (e.g., top, bottom, eight and left directions). When such a position shift takes place, if the meaning of the shift in the digital device is determined as raising a priority for example, recommended applications/contents in a currently provide list can be rearranged or reconfigured according to the meaning. This identically applies to a category. So to speak, as positions of the category menu items arranged in the category region can be moved or changed, a user can change a recommended application/content list configuration which is arranged or will be arranged according to the changed positions.

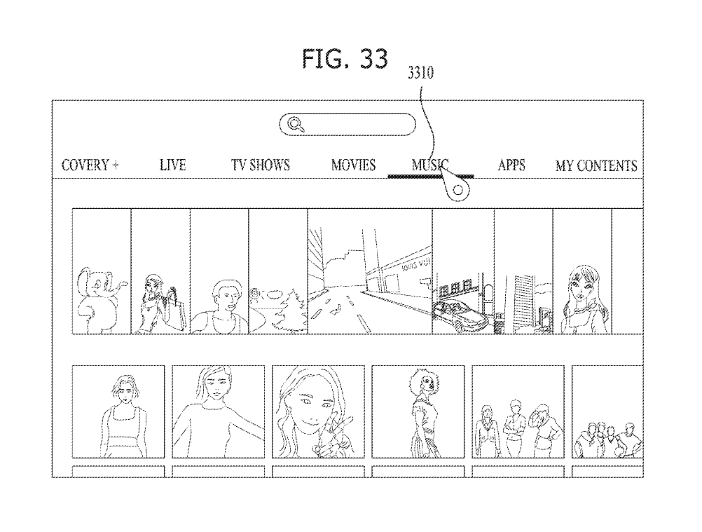

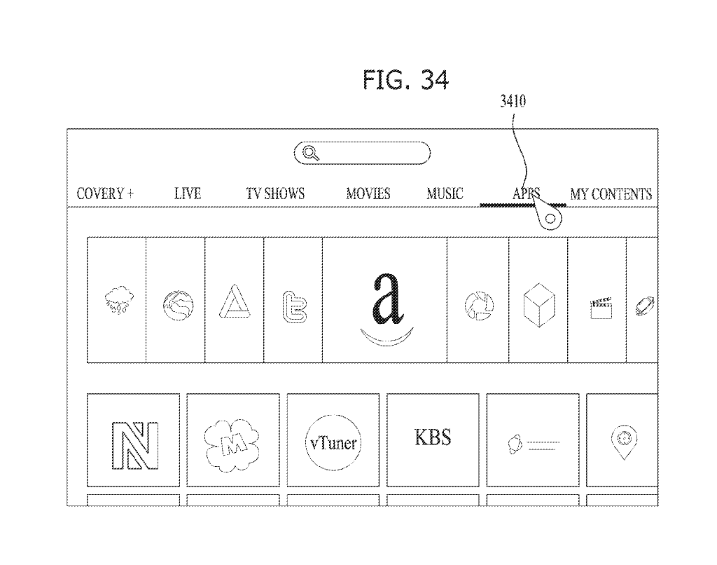

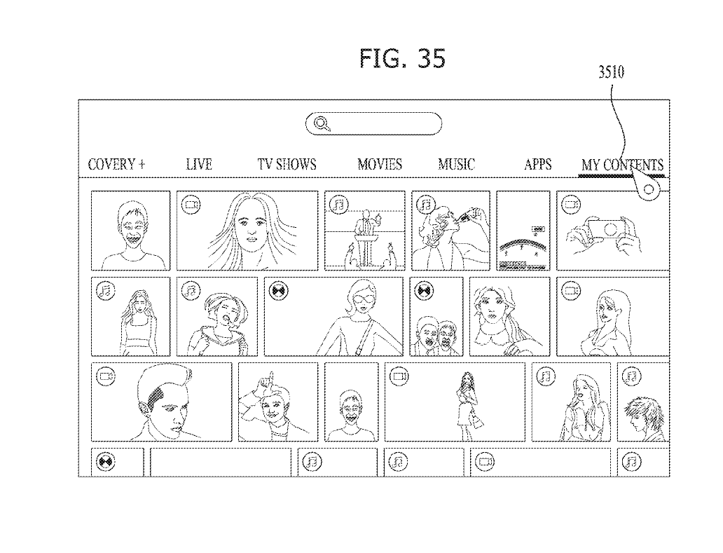

FIG. 33 provides a recommended application/content list belonging to a music category 3310, FIG. 34 provides a recommended application/content list belonging to an application category 3410, and FIG. 35 provides a recommended application/content list belonging to a my contents category 3510.

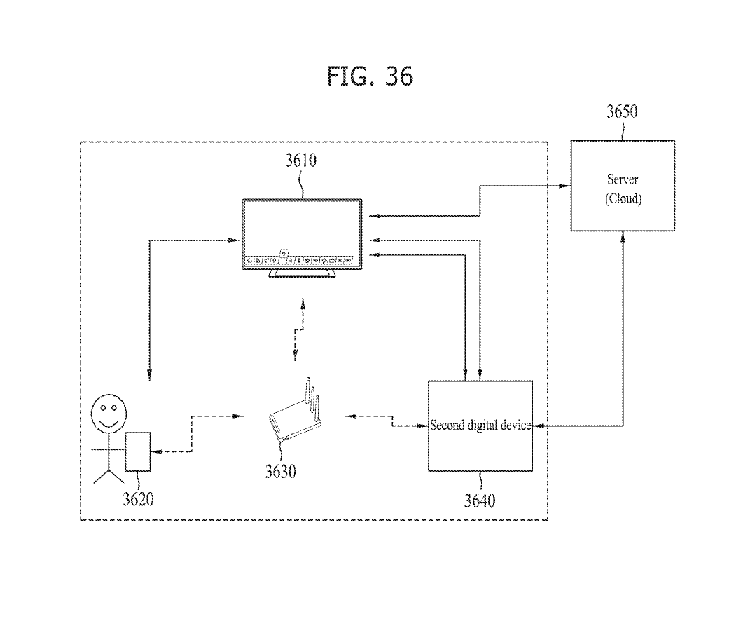

FIG. 36 is a diagram to describe one example of a digital service system according to one embodiment of the present invention in detail.

Referring to FIG. 36, through data communication with an external server (e.g., cloud server, etc.) 3650, a digital device 3610 and a second digital device 3640 can receive menu configuration data for menu configuration according to the present invention and application/content data for application/content or the like of a menu item in the menu. Meanwhile, a mobile device 3620 or a relay 3630 may perform data communication with the external server 3650 as well as the digital device 3610 and the second digital device 3640. Moreover, the mobile device 3620, the relay 3630 and the second digital device 3640 may forward the data received through the data communications with the external server 3610 for the menu configuration of the digital device 3610 and the like. In doing so, the data to be forwarded may be delivered by being processed for format change and the like if necessary.

Meanwhile, at least one of the mobile device 3620, the relay 3630 and the second digital device 3640 may receive and output menu data provided by the digital device 3610. For example, if the digital device is outputting a present mode menu, at least one of the mobile device 3620 and the second digital device 3640 receives and outputs the present mode menu and may also receive and output a menu of a past or future mode as well as the present mode. Moreover, each of the mobile device 3620 and the second digital device 3640 may receive and output menu data of different modes from the digital device 3610, respectively.

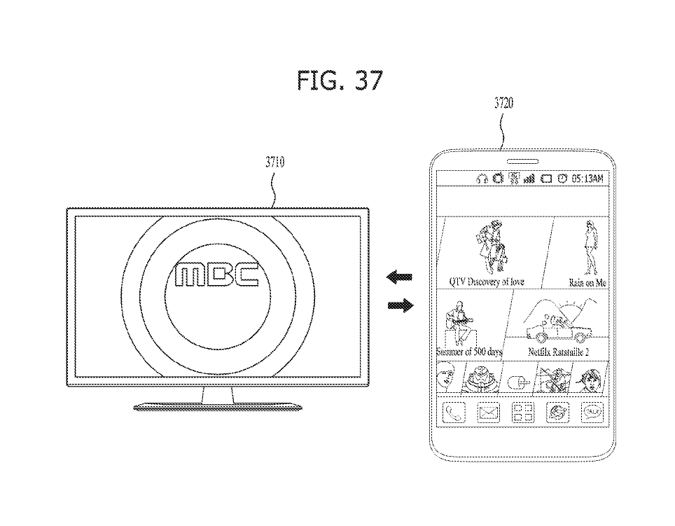

FIG. 37 is a diagram showing one example of an embodiment that a menu requested in a digital device 3710 is transmitted to and outputted from a mobile device 3720 according to one embodiment of the present invention.

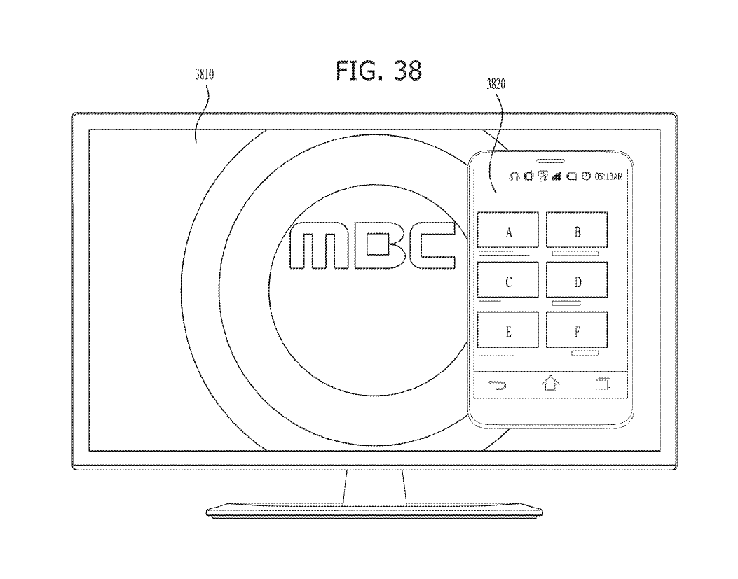

Meanwhile, FIG. 38 may show an embodiment for a menu launcher configuration of a new menu launcher type, i.e., a mobile device type according to the present invention. For another example, FIG. 38 may show a UI implemented in a manner that various menus, data, applications and the like of a mobile device can be run in a digital device according to running an application such as OSP of a mobile device.

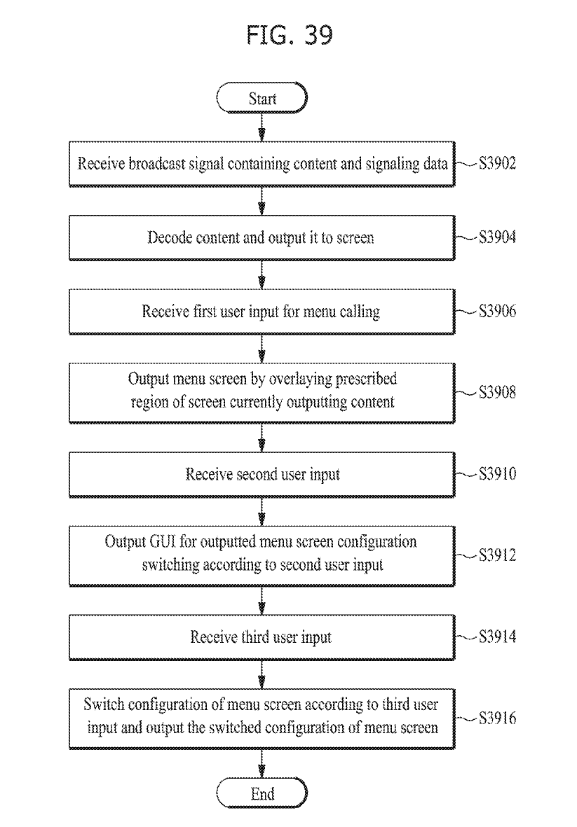

FIG. 39 is a flowchart to describe a menu data processing method in a digital device according to the present invention.

A digital device receives a broadcast signal containing a content and signaling data [S3902], decodes the received content and signaling data, and then outputs them to a screen [S3904].

If receiving a first user input signal for a menu calling [S3906], the digital device configures a menu screen in a prescribed region of the content outputted screen and then outputs it in overlay form [S3908].

Thus, after the menu has been outputted together with the content, if a second user input signal is received [S3910], the digital device outputs a GUI for the outputted menu screen configuration switching according to the user input signal [S3912].

If receiving a third user input signal [S3914], the digital device switches and outputs a configuration of the menu screen according to the third user input signal [S3916].

Meanwhile, a method of providing a menu screen in a digital device according to one embodiment of the present invention may include receiving a content and a signaling data for the content, decoding the content and the signaling data, outputting the decoded content to a screen, receiving a first user input for a menu calling, outputting a menu screen to overlay a prescribed region of the content outputted screen in response to the first user input, the menu screen including an application list or a content list including at least one content related to the content currently outputted to the screen, detecting whether a pointer within the menu screen is located at or hovering on a prescribed region, outputting a GUI for a menu screen configuration switching of the outputted menu screen, and switching to output the menu screen configuration in response to a user's selection from the outputted GUI.

A method of providing a menu screen in a digital device according to another embodiment of the present invention may include receiving a content and a signaling data for the content, decoding the content and the signaling data, outputting the decoded content to a screen, collecting a history data for one or more contents used for the device, receiving a first user input for a menu calling, outputting a menu screen to overlay a prescribed region of the content outputted screen in response to the first user input, the menu screen including an application list or a content list including at least one content related to the content currently outputted to the screen, receiving a second user input for a menu selection, and outputting a timeline based content list by referring to the collected history data for the one or more contents in response to the second user input.

A method of providing a menu screen in a digital device according to further embodiment of the present invention may include receiving a content and a signaling data for the content, decoding the content and the signaling data, outputting the decoded content to a screen, receiving a first user input for a menu calling, outputting a menu screen to overlay a prescribed region of the content outputted screen in response to the first user input, the menu screen including an application list or a content list including at least one content related to the content currently outputted to the screen and an icon for entering a submenu screen, detecting whether a pointer within the menu screen is located at or hovering on the icon, and outputting the submenu screen, wherein the submenu screen includes one or more categories, wherein each of the categories includes a content list including one or more contents, and wherein the contents belonging to the content list is arranged based on at least one of time data including a season, weather data, emotional data associated with at least one of the time data and the weather data, retrieval ranking, and user's content use pattern data.

### MODE FOR INVENTION

According various embodiments of the present invention, a digital device enables a user to access a desired function, data (e.g., content, etc.) more easily and quickly than the related art. And, the digital device enables desired data to be accessed and used more easily and quickly through minimum depth or screen change on a paged menu while minimizing disturbance in watching a content currently outputted to a main screen, i.e., a currently watched content. Moreover, the digital device configures and provides a more intuitive menu screen with maximized use convenience than the related art so as to enable everyone to use the digital device easily and conveniently.

A digital device and controlling method thereof according to the present invention can be achieved by combination of structural elements and features of the present invention. Each of the structural elements or features should be considered selectively unless specified separately. Also, some structural elements and/or features may be combined with one another to enable various modifications of the embodiments of the present invention. The description with reference to each drawing in the present specification may limited to the description of the corresponding drawing, by which the technical idea of the present invention is non-limited. Hence, contents failing to conflict with each other in the contents shown in the corresponding drawing or mentioned in the description part of the corresponding drawing are applicable to a related drawing or a description part of the related drawing intactly or by being appropriately combined together, which is included in the technical idea of the present invention as well.

Meanwhile, a digital device operating method of the present invention can be implemented in a program recorded medium, which can be read by a processor provided to the digital device, as processor-readable codes. The processor-readable media may include all kinds of recording devices in which data readable by a processor are stored. The processor-readable media may include ROM, RAM, CD-ROM, magnetic tapes, floppy discs, optical data storage devices, and the like for example and also include carrier-wave type implementations (e.g., transmission via Internet). Further, the recording medium readable by a processor is distributed to a computer system connected to a network, whereby codes readable by the processor by distribution can be saved and executed.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents. And, such modifications and variations should not be individually understood from the technical idea or prospect of the present invention.

### INDUSTRIAL APPLICABILITY

The present invention relates to a digital device and is applicable to digital devices of various types. Therefore, the present invention has industrial applicability.

1. A digital device, comprising:
a receiving unit receiving a content and a signaling data for the content;
a user input receiving unit receiving a first user input for a menu calling;
a decoder decoding the content and the signaling data;
a controller configured to control the decoded content to be outputted to a screen and control a menu screen to be outputted to overlay a prescribed region of the content outputted screen in response to the first user input; and
an output unit outputting the content and the menu screen,
wherein the controller controls the menu screen to be outputted by including an application list or a content list including at least one content related to the content currently outputted to the screen and
wherein if a pointer within the menu screen is located at or hovering on a prescribed region, the controller is configured to control a GUI to be outputted for a menu screen configuration switching of the outputted menu screen and control the menu screen configuration to be switched in response to a user's selection from the outputted GUI.

2. The digital device of claim 1, wherein the controller collects history data for the application list configuring the menu screen.

3. The digital device of claim 2, wherein the controller controls a preview image to be outputted to one or more applications included in the application list configuring the menu screen based on the collected history data.

4. The digital device of claim 1, wherein the controller identifies one or more contents included in the content list of the menu screen and controls data for the identified one or more contents to be read from a memory or/and collected from an external server.

5. The digital device of claim 4, wherein the data for the identified one or more contents includes history data for the corresponding content and wherein in configuring the content list of the menu screen, the controller controls a preview image for the corresponding content to be outputted based on the history data.

6. A digital device, comprising:
a receiving unit receiving a content and a signaling data for the content;
a user input receiving unit receiving a first user input for a menu calling;
a decoder decoding the content and the signaling data;
a controller configured to control the decoded content to be outputted to a screen and control a menu screen to be outputted to overlay a prescribed region of the content outputted screen in response to the first user input; and
an output unit outputting the content and the menu screen,
wherein the controller controls the menu screen to be outputted by including an application list installed on the digital device and
wherein the controller collects history data for the application list configuring the menu screen and controls a preview image to be outputted to one or more applications included in the application list configuring the menu screen based on the collected history data.

7. (canceled)

8. A digital device, comprising:
a receiving unit receiving a content and a signaling data for the content;
a user input receiving unit receiving a first user input for a menu calling and a second user input for a menu selection;
a decoder decoding the content and the signaling data;
a controller configured to collect a history data for one or more contents used for the device, control the decoded content to be outputted to a screen, and control a menu screen to be outputted to overlay a prescribed region of the content outputted screen in response to the first user input; and
an output unit outputting the content and the menu screen,
wherein the controller controls the menu screen to be outputted by including an application list or a content list including at least one content related to the content currently outputted to the screen in response to the first user input and
wherein the controller controls a timeline based content list to be outputted by referring to the collected history data for the one or more contents in response to the second user input.

9. The digital device of claim 8, wherein when a corresponding content is a live broadcast program, if the live broadcast program stops being broadcasted, the controller controls the live broadcast program to be excluded from the outputted timeline based content list.

10. The digital device of claim 8, wherein when a corresponding content is a streamed or downloaded content, if the corresponding content is completely played, the controller controls the corresponding content to be excluded from the outputted timeline based content list.

11. The digital device of claim 8, wherein when a corresponding content is restricted by a viewable time or rating, if the viewable time for the content expires or the viewable rating is changed, the controller controls the corresponding content to be excluded from the outputted timeline based content list.

12. The digital device of claim 8, wherein if a prescribed content belonging to the timeline based content list is selected, the controller controls one or more contents related to the selected content among contents belonging to the content list to be outputted in a manner of being arranged to be adjacent to the selected content.

13. The digital device of claim 12, wherein if the content selection is released, the controller controls the content list to be outputted in a manner of being arranged as the timeline based content list before the selection.

14-15. (canceled)

16. A digital device, comprising:
a receiving unit receiving a content and a signaling data for the content;
a user input receiving unit receiving a first user input and a second user input related to a menu;
a decoder decoding the content and the signaling data;
a controller configured to control the decoded content to be outputted to a screen and control a menu screen to be outputted to overlay a prescribed region of the content outputted screen in response to the first user input; and
an output unit outputting the content and the menu screen,
wherein the controller controls the menu screen to be outputted by including an application list or a content list including at least one content related to the content currently outputted to the screen and an icon for entering a submenu screen,
wherein if a pointer within the menu screen is located at or hovering on the icon, the controller is configured to control the submenu screen to be outputted,
wherein the submenu screen includes one or more categories,
wherein each of the categories includes a content list including one or more contents, and
wherein the contents belonging to the content list is controlled to be arranged based on at least one of time data including a season, weather data, emotional data associated with at least one of the time data and the weather data, retrieval ranking, and user's content use pattern data.

17. The digital device of claim 16, wherein the controller controls the icon for entering the submenu screen to be changed based on the time data including the season.

18. The digital device of claim 17, wherein the controller controls the arranged contents to be outputted by differing from each other in size based on at least one of the time data including the season, the weather data, the emotional data associated with the at least one of the time data and the weather data, the retrieval ranking, and the user's content use pattern data and an attribute of a corresponding content.

19. The digital device of claim 16, wherein if a prescribed content is selected within a corresponding category, the controller controls one or more contents associated with the selected content to be provided by being accessibly rearranged to be adjacent to the selected content.

20. The digital device of claim 19, wherein if the content selection is released, the controller controls rearrangement to be performed in arrangement order before the selection.

21-22. (canceled)
